(19) United States
(12) Patent Application Publication
(10) Pub. No.: US 2016/0065427 A1
(43) Pub. Date: Mar. 3, 2016

(54) COMMUNICATION SYSTEM, CONTROL APPARATUS, INFORMATION COLLECTION METHOD, AND PROGRAM

(71) Applicant: NEC CORPORATION, Tokyo (JP)

(72) Inventor: Yusuke SHINOHARA, Tokyo (JP)

(21) Appl. No.: 14/779,313

(22) PCT Filed: Mar. 27, 2014
(86) PCT No.: PCT/JP2014/058752

§ 371 Date: Sep. 22, 2015

(30) Foreign Application Priority Data
Mar. 28, 2013 (JP) 2013-069130

(51) Int. Cl. H04L 12/26; H04L 12/803

(52) U.S. Cl. CPC H04L 43/062; H04L 43/0882; H04L 47/125

(57) ABSTRACT

A communication system includes: a plurality of nodes; a link(s) for forwarding a packet(s) between (and/or among) the plurality of nodes; and a control apparatus that collects information about the link(s) from a node selected based on a load on the node from the plurality of nodes.

### REFERENCE TO RELATED APPLICATION

This application is based upon and claims the benefit of the priority of Japanese Patent Application No. 2013-069130 filed on Mar. 28, 2013, the disclosure of which is incorporated herein in its entirety by reference thereto.

### TECHNICAL FIELD

The present invention relates to a communication system, a control apparatus, an information collection method, and a program. In particular, it relates to: a communication system in which a control apparatus collects information about a link(s) from a node(s); a control apparatus; an information collection method; and a program.

### BACKGROUND

Each of the following PTLs 1 and 2 discloses a technique for collecting information about a link between nodes from a node in a communication system.

PTL 1 discloses an invention which relates to a network monitoring system that monitors a network. This system acquires, from an individual switch apparatus included in the network, information about traffic transmitted and received via each port of the switch apparatus at intervals of a predetermined period (a traffic acquisition period T).

PTL 2 discloses an invention in which, when a measuring apparatus acquires the communication load on a virtual calculation machine, in place of the virtual calculation machine or a physical calculation machine on which the virtual calculation machine operates, a switch (a correspondent switch) connected to these calculation machines measures and supplies the communication load on the virtual calculation machine. In PTL 2, since the correspondent switch measures and supplies the communication load on the virtual calculation machine, the virtual calculation machine and the physical calculation machine do not need to perform processing relating to notification of the communication load. Thus, it is possible to suppress increase in the processing load on the virtual calculation machine and the physical calculation machine.

### CITATION LIST

### Patent Literature

PTL 1: International Publication No. WO2009/040903
PTL 2: Japanese Patent Kokai Publication No. JP2008-271050A

### SUMMARY

### Technical Problem

When a node notifies a network monitoring system of information about a link, processing required for the notification of the information increases the load on the node.

Since the network monitoring system in PTL 1 collects information from a switch apparatus at intervals of a predetermined period, timing of the information collection may coincide with when the communication load on the switch apparatus is high. In such case, the load on the switch apparatus is further increased by the processing for notifying the network monitoring system of the transmitted and received traffic, which is counted as a problem.

According to PTL 2, by causing the correspondent switch to perform collection and notification of the information in place of the virtual calculation machine or the physical calculation machine, the load on the virtual calculation machine or the physical calculation machine is reduced. However, as is the case with PTL 1, PTL 2 does not disclose or suggest reduction of the load required in the information collection performed by the correspondent switch.

It is an object of the present invention to reduce, when information is collected from a node(s) in a communication system, increase in the load(s) on the node(s) accompanying the information collection.

### Solution to Problem

According to a first aspect of the present invention, there is provided a communication system comprising: a plurality of nodes; a link(s) for forwarding a packet(s) between (and/or among) the plurality of nodes; and a control apparatus that collects information about the link(s) from a node selected based on a load on the node from the plurality of nodes.

According to a second aspect of the present invention, there is provided a control apparatus in a communication system including a plurality of nodes and a link(s) for forwarding a packet(s) between (and/or among) the plurality of nodes. The control apparatus selects a node based on a load on the node from the plurality of nodes and collects information about the link(s) from the selected node.

According to a third aspect of the present invention, there is provided an information collection method in a communication system including a plurality of nodes and a link(s) for forwarding a packet(s) between (and/or among) the plurality of nodes. The information collection method comprises: selecting a node based on a load on the node from the plurality of nodes; and collecting information about the link(s) from the selected node.

According to a fourth aspect of the present invention, there is provided a program for a control apparatus in a communication system including a plurality of nodes and a link(s) for forwarding a packet(s) between (and/or among) the plurality of nodes. The program causes the control apparatus to execute: selecting a node based on a load on the node from the plurality of nodes; and collecting information about the link(s) from the selected node. The program may be recorded in a non-transitory computer-readable storage medium and provided as a program product.

### Advantageous Effects of Invention

According to the present invention, it is possible to reduce, when information is collected from a node in a communication system, increase in the load on the node accompanying the information collection.

### BRIEF DESCRIPTION OF DRAWINGS

FIG. 1 illustrates an exemplary configuration of a system according to an exemplary embodiment of the present invention.

FIG. 2 illustrates an exemplary configuration of a control apparatus according to the exemplary embodiment of the present invention.

FIG. 3 illustrates an exemplary configuration of a system according to a first exemplary embodiment of the present invention.

FIG. 4 illustrates an exemplary configuration of a control apparatus according to the first exemplary embodiment of the present invention.

FIG. 5 illustrates an exemplary configuration of a link information DB included in the control apparatus according to the first exemplary embodiment of the present invention.

FIG. 6 illustrates an exemplary configuration of a node according to the first exemplary embodiment of the present invention.

FIG. 7 illustrates an exemplary configuration of a traffic amount DB (database) included in the node according to the first exemplary embodiment of the present invention.

FIG. 8 is a flowchart illustrating an exemplary operation of the control apparatus according to the first exemplary embodiment of the present invention.

FIG. 9 is a flowchart illustrating an exemplary operation of the node according to the first exemplary embodiment of the present invention.

FIG. 10 illustrates an exemplary configuration of a control apparatus according to a second exemplary embodiment of the present invention.

FIG. 11 illustrates an exemplary configuration of a node information DB included in the control apparatus according to the second exemplary embodiment of the present invention.

FIG. 12 illustrates another exemplary configuration of the node information DB included in the control apparatus according to the second exemplary embodiment of the present invention.

FIG. 13 illustrates an exemplary configuration of a system according to a third exemplary embodiment of the present invention.

FIG. 14 illustrates an exemplary configuration of a link information DB included in a control apparatus according to the third exemplary embodiment of the present invention.

FIG. 15 illustrates an exemplary configuration of a node according to the third exemplary embodiment of the present invention.

FIG. 16 illustrates an exemplary configuration of a traffic amount DB included in the node according to the third exemplary embodiment of the present invention.

FIG. 17 is a flowchart illustrating an exemplary operation of the control apparatus according to the third exemplary embodiment of the present invention.

FIG. 18 is a flowchart illustrating an exemplary operation of the node according to the third exemplary embodiment of the present invention.

FIG. 19 illustrates an exemplary configuration of a link information DB included in a control apparatus according to a fourth exemplary embodiment of the present invention.

FIG. 20 is a flowchart illustrating an exemplary operation of the control apparatus according to the fourth exemplary embodiment of the present invention.

FIG. 21 illustrates an exemplary configuration of a system according to a fifth exemplary embodiment of the present invention.

FIG. 22 illustrates an exemplary configuration of a control apparatus according to the fifth exemplary embodiment of the present invention.

FIG. 23 illustrates an exemplary configuration of a determination management unit included in the control apparatus according to the fifth exemplary embodiment of the present invention.

FIG. 24 illustrates another exemplary configuration of the determination management unit included in the control apparatus according to the fifth exemplary embodiment of the present invention.

FIG. 25 illustrates an exemplary operation of the control apparatus according to the fifth exemplary embodiment of the present invention.

FIG. 26 illustrates an exemplary technique that relates to a sixth exemplary embodiment of the present invention.

FIG. 27 illustrates an exemplary technique that relates to the sixth exemplary embodiment of the present invention.

FIG. 28 illustrates an exemplary configuration of a system according to the sixth exemplary embodiment of the present invention.

FIG. 29 illustrates an exemplary configuration of a control apparatus according to the sixth exemplary embodiment of the present invention.

FIG. 30 illustrates an exemplary configuration of a processing rule DB included in the control apparatus according to the sixth exemplary embodiment of the present invention.

FIG. 31 illustrates an exemplary configuration of a node according to the sixth exemplary embodiment of the present invention.

FIG. 32 illustrates an exemplary operation of the control apparatus according to the sixth exemplary embodiment of the present invention.

FIG. 33 illustrates an exemplary operation of the node according to the sixth exemplary embodiment of the present invention.

### DESCRIPTION OF EMBODIMENTS

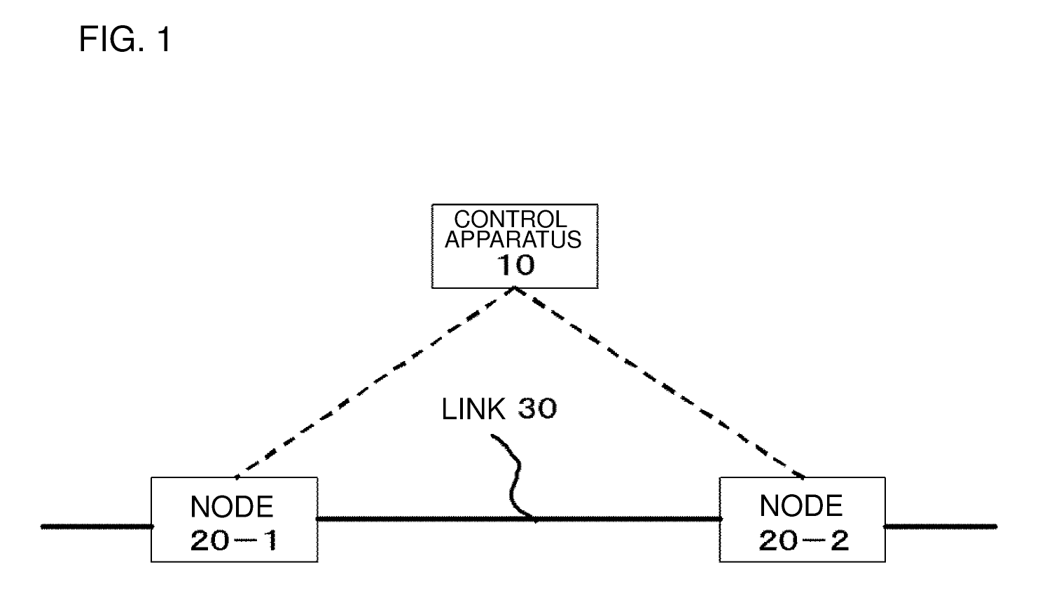

First, an outline of an exemplary embodiment of the present invention will be described with reference to the drawings. As illustrated in FIG. 1, the present invention can be realized by a configuration that includes a control apparatus 10 and nodes 20-1 to 20-2 (hereinafter, each of the nodes 20-1 and 20-2 will be referred to as a “node 20” unless these nodes need to be distinguished from each other). In the following outline, various components are denoted by reference signs for the sake of convenience. Namely, the following reference signs are merely used as examples to facilitate understanding of the present invention, not to limit the present invention to the illustrated modes.

As illustrated in FIG. 1, the nodes 20-1 and 20-2 are connected to each other via a link 30.

The control apparatus 10 serves as means for managing the plurality of nodes 20. The control apparatus 10 collects, from the plurality of nodes 20, information about the link 30 included in a network formed by the plurality of nodes 20.

For example, the information about the link 30 represents the traffic amount of the link 30. For example, the information about the link 30 may represent packet delay time of the link 30. For example, the information about the link 30 may represent failure information about the link 30. The information about the link 30 is not limited to these examples. Any information that represents information about the link 30 is applicable.

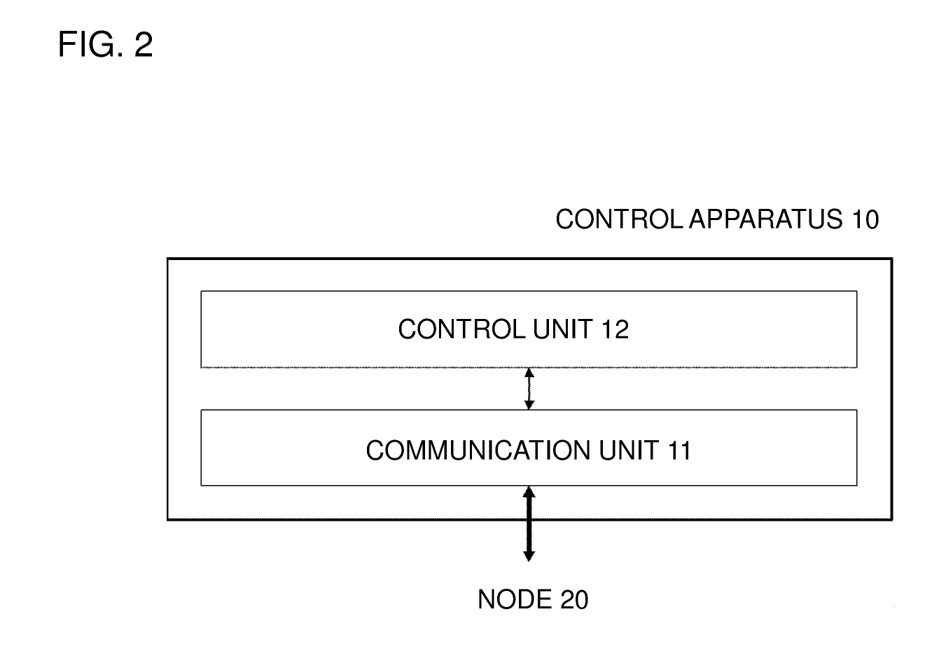

FIG. 2 illustrates an exemplary configuration of the control apparatus 10. As illustrated in FIG. 2, the control apparatus 10 includes a communication unit 11 and a control unit 12.

For example, the control unit 12 communicates with each of the nodes 20 via the communication unit 11.

For example, the control unit 12 collects the information about the link 30 when a predetermined condition(s) is met. For example, the control unit 12 collects the information about the link 30 at intervals of a predetermined period. For example, the control unit 12 collects the information about the link 30 when a configuration of the plurality of nodes 20 is changed. For example, the control unit 12 collects the information about the link 30 when performing packet path control.

For example, when collecting the information about the link 30, between the two nodes 20 connected to the link 30, the control unit 12 collects the information about the link 30 from a node that is determined based on the loads on the nodes 20. For example, when collecting the information about the link 30, between the two nodes 20 connected to the link 30, the control unit 12 collects the information about the link 30 from a node having the smaller load.

For example, the load on a node 20 is the load on a CPU of the node 20. For example, the load on a node 20 corresponds to a total traffic amount of the node 20. For example, the total traffic amount processed by a node 20 corresponds to the total number of packets processed by the node 20 per unit time. For example, the load on a node 20 corresponds to the number of active ports of the node 20. For example, the load on a node 20 corresponds to the percentage of active ports of the node 20. For example, the percentage of active ports of a node 20 is the percentage of active ports of all the ports of the node 20. The load on a node 20, of which the control apparatus 10 is notified, is not limited to the above examples. Any information that represents load on a node 20 is applicable.

For example, each node 20 notifies the control unit 12 of information about its own load at intervals of a predetermined period.

For example, the control unit 12 may request each node 20 to provide the information about its own load and may be notified of the information about the load in response to the request. By using the information about the load provided by each node 20, the control unit 12 determines a node to collect the information about the link 30.

With such configuration as described above, between the two nodes 20 connected to the link 30, the control apparatus 10 collects information about the link 30 from a node that is determined based on the loads on the nodes 20. Thus, load concentration on a certain node can be prevented.

### First Exemplary Embodiment

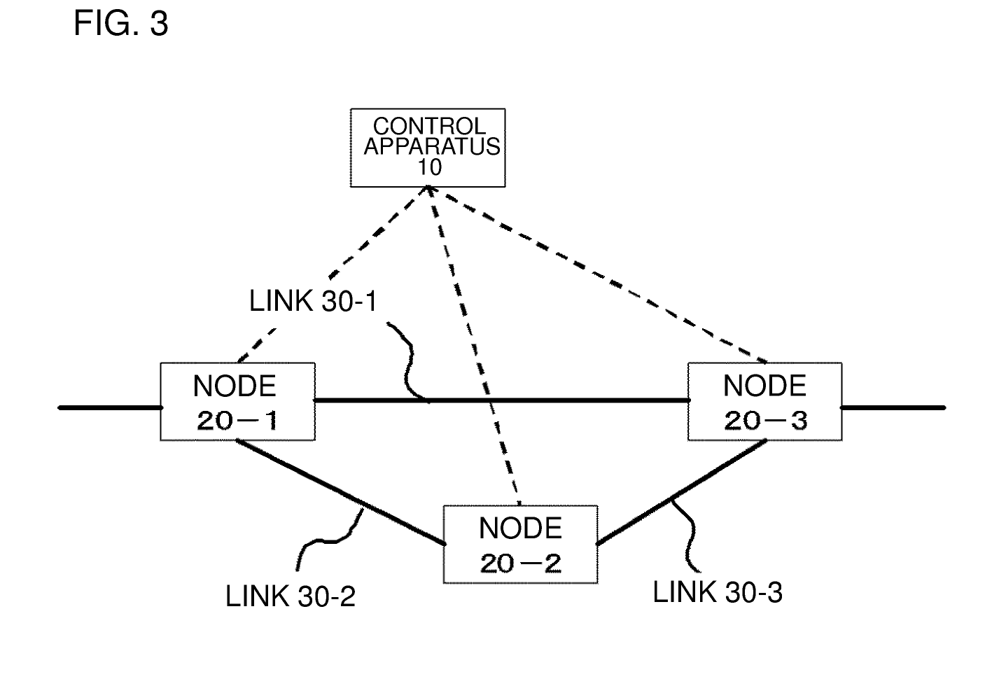

A first exemplary embodiment of the present invention will be described with reference to the drawings. As illustrated in FIG. 3, the first exemplary embodiment of the present invention can be realized by a configuration including a control apparatus 10 and nodes 20. As illustrated in FIG. 3, nodes 20-1 to 20-3 are connected to each other via links 30-1 to 30-3 (hereinafter, each of the links 30-1 to 30-3 will be referred to as a “link 30” unless these links need to be distinguished from each other).

The control apparatus 10 serves as means for managing the plurality of nodes 20.

From the plurality of nodes 20, the control apparatus 10 collects information about the links 30 included in a network formed by the plurality of nodes 20. The first exemplary embodiment of the present invention will be described based on an example in which the control apparatus 10 collects the traffic amount of a link 30 as information about the link 30. However, the information about a link 30 collected by the control apparatus 10 is not limited to the traffic amount of the link 30.

In the example in FIG. 3, the control unit 12 collects the traffic amount of each of the links 30-1 to 30-3. For example, the control apparatus 10 uses the collected traffic amounts of the links 30 for managing the plurality of nodes 20. In addition, for example, the control apparatus 10 uses the collected traffic amounts of the links 30 for performing path control on packets forwarded by a plurality of nodes 20.

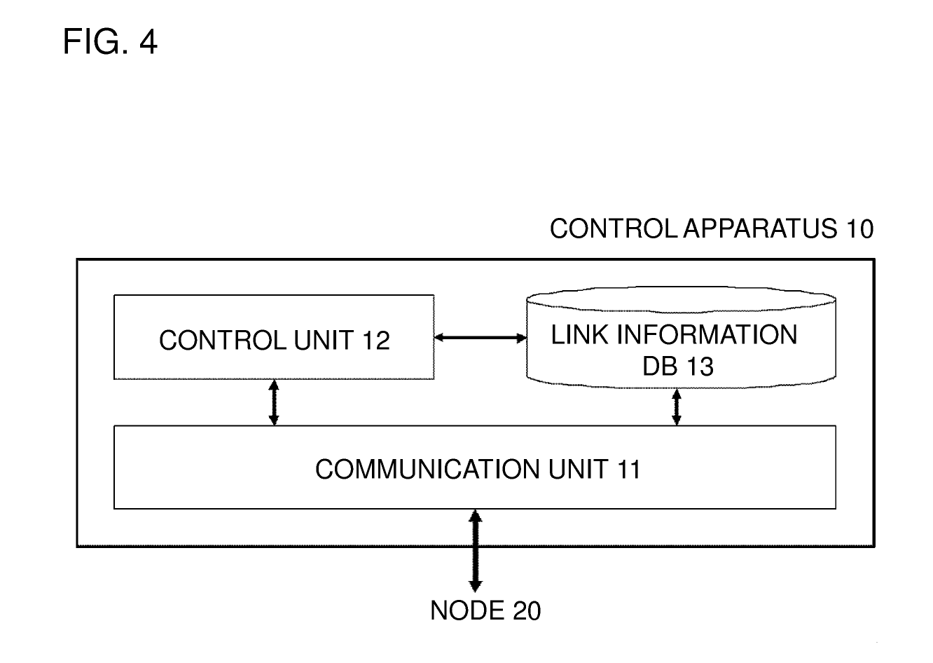

FIG. 4 illustrates an exemplary configuration of the control apparatus 10. As illustrated in FIG. 4, the control apparatus 10 includes a communication unit 11, a control unit 12, and a link information DB 13.

For example, when collecting a traffic amount, the communication unit 11 transmits a message that requests notification of the traffic amount to a node 20. The communication unit 11 receives a message that indicates the traffic amount from the node 20 in response to the message requesting the traffic amount.

For example, the control unit 12 collects the traffic amount(s) of a link(s) 30 at intervals of a predetermined period. For example, the control unit 12 collects the traffic amount(s) of a link(s) 30 when a configuration of the plurality of nodes 20 is changed. For example, the control unit 12 collects the traffic amount(s) of a link(s) 30 when performing packet path control.

For example, the control unit 12 stores an identifier of a link whose traffic amount is requested in a message that requests notification of the traffic amount. For example, such identifier is information that uniquely identifies a link 30 included in the network. When requested, a node 20 notifies the control apparatus 10 of the traffic amount of the link 30 that corresponds to the stored identifier.

For example, between two nodes 20 connected to a link 30 whose traffic amount is to be collected, the control unit 12 collects the traffic amount from a node having the smaller processing load. For example, between two nodes 20 connected to a link 30 whose traffic amount is to be collected, the control unit 12 transmits a message that requests notification of the traffic amount to a node having the smaller processing load.

In the example in FIG. 4, for example, when collecting the traffic amount of the link 30-1, between the nodes 20-1 and 20-3 connected to the link 30-1, the control unit 12 collects the traffic amount of the link 30-1 from the node 20-3 having the smaller processing load.

For example, each node 20 notifies the control unit 12 of information about its own processing load at intervals of a predetermined period. For example, the control unit 12 may request each node 20 to provide information about its own processing load and may receive information about the processing load in response to the request.

For example, as the processing load on a node 20, the control unit 12 is notified of information about the load on a CPU in the node 20.

For example, as the processing load on a node 20, the control unit 12 is notified of the total traffic amount of the node 20. For example, the total traffic amount processed by a node 20 corresponds to the total number of packets processed by the node 20 per unit time.

For example, as the processing load on a node 20, the control unit 12 is notified of the number of active ports of the node 20. For example, as the processing load on a node 20, the control unit 12 is notified of the percentage of active ports of the node 20. For example, the percentage of active ports of a node 20 is the percentage of active ports of all the ports of the node 20.

The processing load on a node 20, of which the control apparatus 10 is notified, is not limited to the above examples. Any information that represents processing load on a node 20 is applicable.

For example, between nodes 20, only a node 20 having processing load smaller than a predetermined threshold may notify the control unit 12 of the processing load. Herein, as needed, “between” is used to signify “among.”

For example, between nodes 20, only a node having its CPU load smaller than a predetermined threshold may notify the control unit 12 of information about the CPU load. In such case, between a plurality of nodes 20, the control unit 12 determines that the CPU load on the other node, which does not notify the control unit 12 of its CPU load, is equal to or more than the predetermined threshold. The control unit 12 having the above configuration is not notified by the node 20 whose CPU load is high. Thus, the control unit 12 can grasp the statuses of the CPU loads of the nodes 20, without further increasing the node whose load is already high.

For example, between nodes 20, only a node having its total traffic amount smaller than a predetermined threshold may notify the control unit 12 of the total traffic amount. In such case, between a plurality of nodes 20, the control unit 12 determines that the total traffic amount of the other node, which does not notify the control unit 12 of its total traffic amount, is equal to or more than the predetermined threshold. The control unit 12 having the above configuration is not notified by the node whose total traffic amount is large. Thus, the control unit 12 can grasp the statuses of the total traffic amounts of the nodes 20, without increasing the load on the node 20 whose total traffic amount is large.

For example, when the number of active ports of a node is changed, the control unit 12 may be notified by the node 20 of the number of active ports or the percentage of active ports. In such case, when there is no change in the number of active ports, the control unit 12 is not notified of the number of active ports or the percentage of active ports. Thus, increase in the load on the node 20 can be prevented, which would otherwise be caused by the notification processing by the node 20.

For example, between two nodes 20 connected to a link 30 whose traffic amount is to be collected, the control unit 12 collects the traffic amount from a node having the smaller CPU load. For example, between two nodes connected to a link 30 whose traffic amount is to be collected, the control unit 12 collects the traffic amount from a node having a smaller number of active ports or a node having a smaller percentage of active ports. For example, between two nodes 20 connected to a link 30 whose traffic amount is to be collected, the control unit 12 collects the traffic amount from a node having a smaller total traffic amount.

The traffic amounts of the links 30 received from the nodes 20 are stored in the link information DB 13.

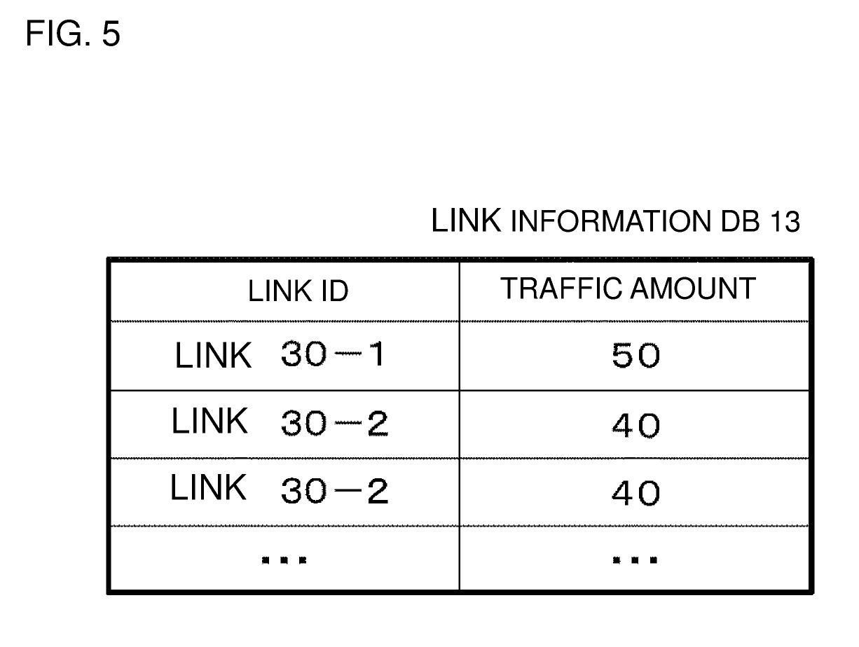

FIG. 5 illustrates an exemplary configuration of the link information DB 13. As illustrated in FIG. 5, the traffic amounts of the links 30 are stored in the link information DB 13 per link. In the example in FIG. 5, a total value of traffic amounts in the forward and reverse directions is stored in the link information DB 13 per link 30. The configuration of the link information DB 13 is not limited to the example in FIG. 5. For example, the traffic amounts in the forward and reverse directions may separately be stored per link 30.

In the example in FIG. 5, in the link information DB 13, a link ID of the link 30-2 is associated with 40, which is a total value of the traffic amounts in the forward and reverse directions of the link 30-2.

The nodes 20 are apparatuses that forward packets.

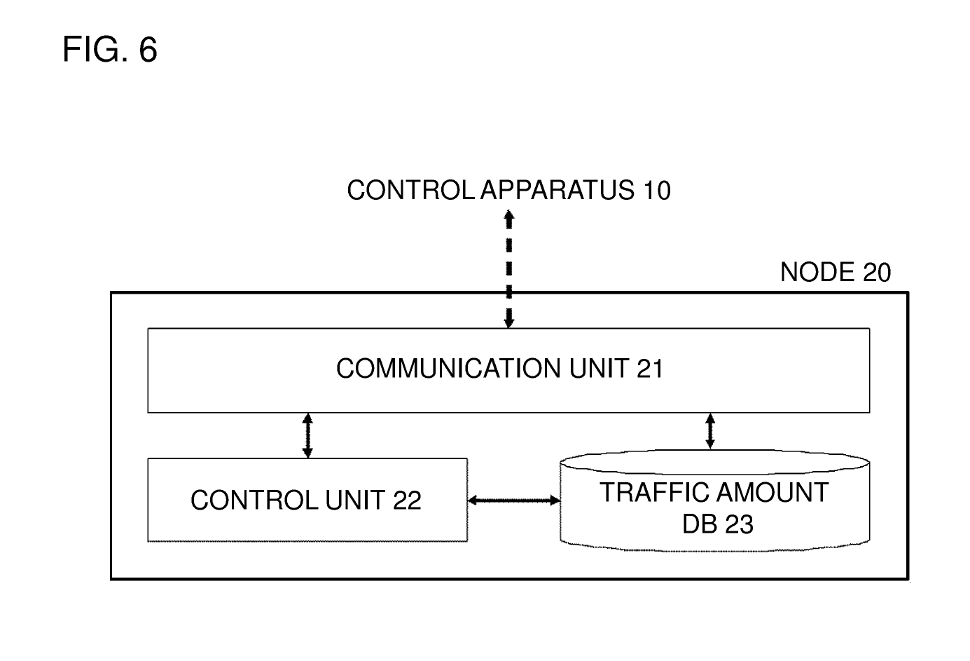

FIG. 6 illustrates an exemplary configuration of a node 20. As illustrated in FIG. 6, the node 20 includes a communication unit 21, a control unit 22, and a traffic amount DB 23.

The communication unit 21 serves as means for transmitting and receiving packets. For example, the communication unit 21 receives a message that requests notification of a traffic amount from the control apparatus 10. For example, in response to the request, the communication unit 21 transmits a message that indicates the traffic amount to the control apparatus 10.

The control unit 22 serves as means for forwarding received packets via the communication unit 21. In addition, when requested by the control apparatus 10 to provide a traffic amount, the control unit 22 notifies the control apparatus 10 of the traffic amount stored in the traffic amount DB 23 in response to the request.

For example, the control unit 22 notifies the control apparatus 10 of the traffic amount of a link that corresponds to a link ID stored in a message received from the control apparatus 10. For example, the control unit 22 refers to the traffic amount DB 23 and grasps the traffic amount of the link that corresponds to the link ID stored in the received message.

For example, the control unit 22 notifies the control apparatus 10 of the grasped traffic amount. For example, the control unit 22 creates a message that notifies the control apparatus 10 of the grasped traffic amount and transmits the created message to the control apparatus 10 via the communication unit 21.

For example, the control unit 22 notifies the control apparatus 10 of information about the processing load on the corresponding node 20. For example, the control unit 22 notifies the control apparatus 10 of information about the processing load on the corresponding node 20 at intervals of a predetermined period. For example, when requested by the control apparatus 10 to provide the processing load on a node 20, the control unit 22 notifies the control apparatus 10 of the processing load.

For example, the processing load on a node 20, of which the corresponding control unit 22 notifies the control apparatus 10, corresponds to the load on a CPU in the node 20, the number of active ports of the node 20, or the total traffic amount of the node 20. The processing load on a node 20, of which the corresponding control unit 22 notifies the control apparatus 10, is not limited to the above examples. Any information that represents the processing load on the node 20 is applicable. Alternatively, the control unit 22 may notify the control apparatus 10 of one or more kinds of processing load on the node 20.

For example, the control unit 22 may be configured not to notify the control apparatus 10 of information about the processing load on the corresponding node 20 if the processing load is equal to or more than a predetermined threshold. For example, the control unit 22 does not notify the control apparatus 10 of the load on a CPU of the node 20 if the CPU load is equal to or more than a predetermined threshold. For example, if the CPU utilization of the node 20 is 70% or more, the control unit 22 does not notify the control apparatus 10 of the CPU load.

For example, if the total traffic amount is equal to or more than a predetermined threshold, the control unit 22 does not notify the control apparatus 10 of the total traffic amount. For example, if the total traffic amount of the node 20 is “100” or more, the control unit 22 does not notify the control apparatus 10 of the total traffic amount.

For example, if the number of active ports is changed, the control unit 22 may notify the control apparatus 10 of information about the number of active ports. For example, if there is no change in the number of active ports, the control unit 22 does not notify the control apparatus 10 of the number of active ports.

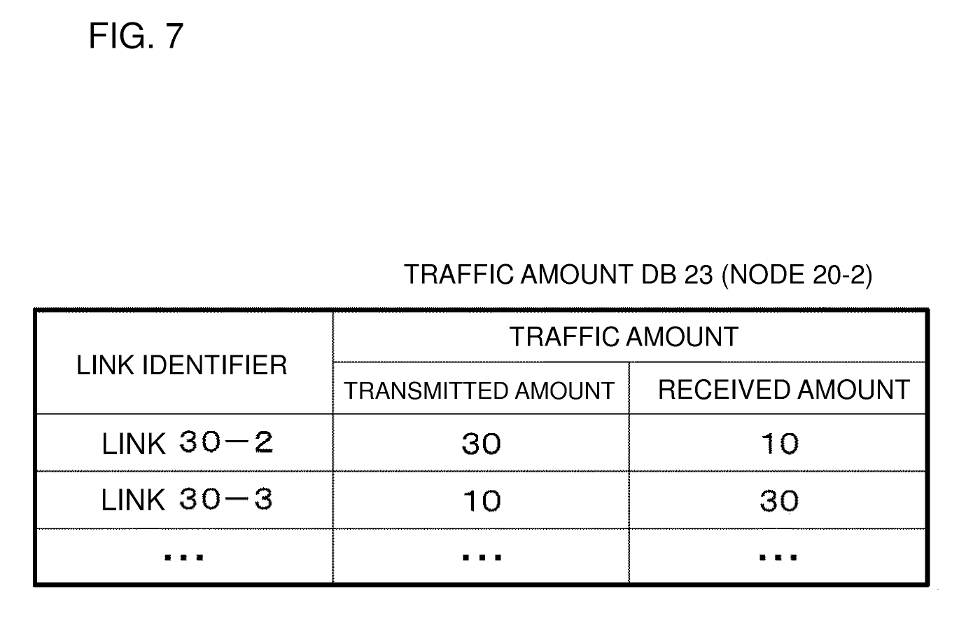

FIG. 7 illustrates an exemplary table configuration of the traffic amount DB 23 included in the node 20-2. For example, in the traffic amount DB 23, a traffic amount is stored for each link 30 connected to the node 20. In the example in FIG. 7, in the traffic amount DB 23, a traffic amount is stored for each of the links 30-2 and link 30-3 connected to the node 20-2.

For example, in the traffic amount DB 23, traffic amounts transmitted and received (a transmitted amount and a received amount) are stored per link 30 connected to the node 20.

In the example in FIG. 7, in the traffic amount DB 23, the link identifier of the link 30-2, “30,” which is the traffic amount transmitted by the node 20-2 via the link 30-2, and “10,” which is the traffic amount received by the node 20-2 via link 30-2 are associated with each other.

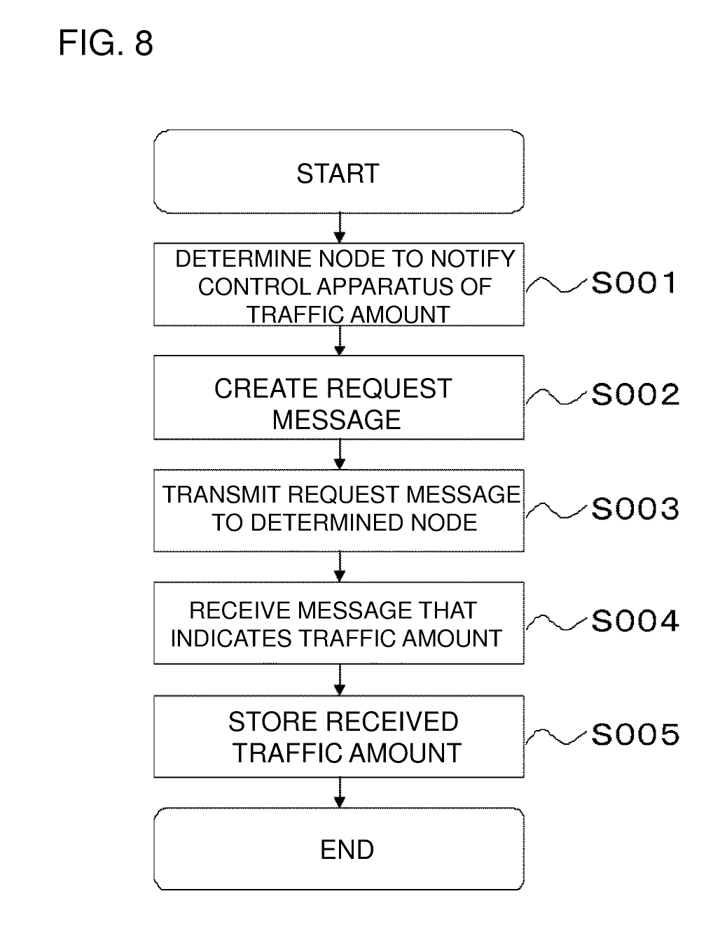

Next, an exemplary operation of the control apparatus 10 according to the first exemplary embodiment of the present invention will be described with reference to the drawings. FIG. 8 is a flowchart illustrating an operation of the control apparatus 10.

When a predetermined condition(s) is met, the control unit 12 in the control apparatus 10 starts collection of the traffic amount of a link 30.

Between nodes 20 connected to the link whose traffic amount is to be collected, the control unit 12 determines a node having the smaller processing load to be the node that the control unit 12 requests for notification of the traffic amount (S001). Next, the control unit 12 creates a message that requests notification of the traffic amount (S002).

The communication unit 11 transmits the message created by the control unit 12 to the determined node (S003).

The communication unit 11 receives a message that indicates the traffic amount of the link from the node (S004).

The traffic amount included in the message received from the node is stored in the link information DB 13 (S005).

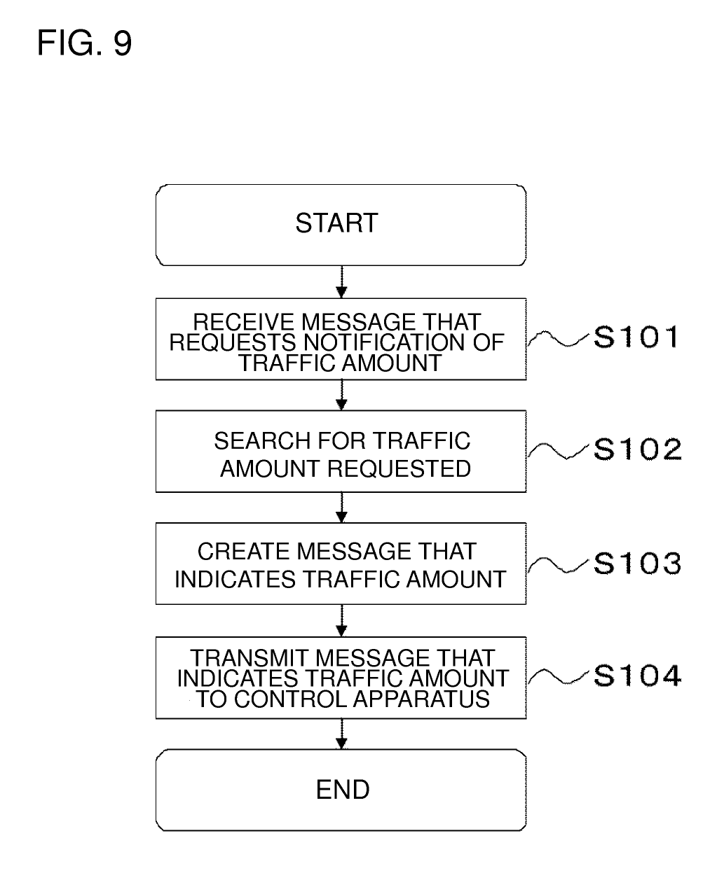

Next, an exemplary operation of a node 20 according to the first exemplary embodiment of the present invention will be described with reference to the drawings. FIG. 9 is a flowchart illustrating an operation of a node 20.

The communication unit 21 of the node 20 receives a message that requests notification of a traffic amount from the control apparatus 10 (S101).

The control unit 22 of the node 20 searches the traffic amount DB 23 for the traffic amount of the link specified in the message received by the communication unit 21 (S 102).

The control unit 22 creates a message that notifies the control apparatus 10 of the traffic amount found (S 103).

The communication unit 21 transmits the message created by the control unit 22 to the control apparatus 10 (S104).

With the above configuration, between nodes 20 connected to a link 30, the control apparatus 10 collects information about the link 30 from a node having the smaller load. Thus, load concentration on a certain node can be prevented.

### Second Exemplary Embodiment

Next, a second exemplary embodiment of the present invention will be described with reference to the drawings. In the second exemplary embodiment, to determine a node that notifies a control apparatus 10 of information about a link 30, the control apparatus 10 refers to a node information DB in which information about the nodes 20 is stored. The second exemplary embodiment includes configurations that are equivalent to those according to the first exemplary embodiment, and the description of such configurations will be omitted.

The second exemplary embodiment of the present invention is applicable to the above first exemplary embodiment.

From a plurality of nodes 20, the control apparatus 10 collects information about links 30 included in a network formed by the plurality of nodes 20. The second exemplary embodiment of the present invention will be described based on an example in which the control apparatus 10 collects the traffic amount of a link 30 as information about the link 30. However, the information about a link 30 collected by the control apparatus 10 is not limited to the traffic amount of the link 30.

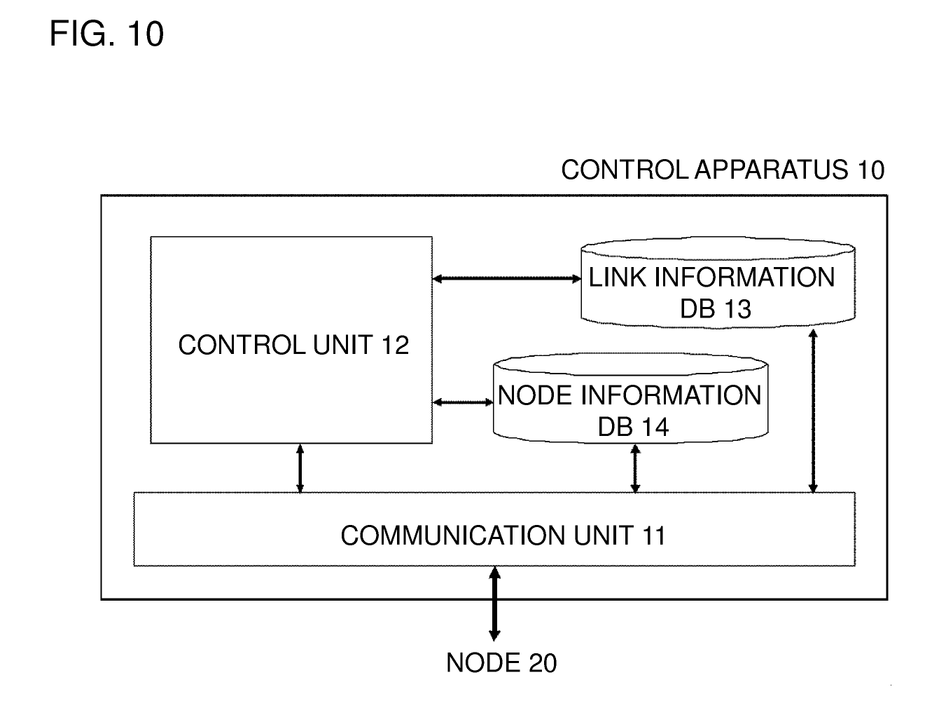

FIG. 10 illustrates an exemplary configuration of the control apparatus 10 according to the second exemplary embodiment of the present invention. As illustrated in FIG. 10, the control apparatus 10 includes a communication unit 11, a control unit 12, a link information DB 13, and a node information DB 14.

Information about the processing loads on the nodes 20 is stored in the node information DB 14 per node 20.

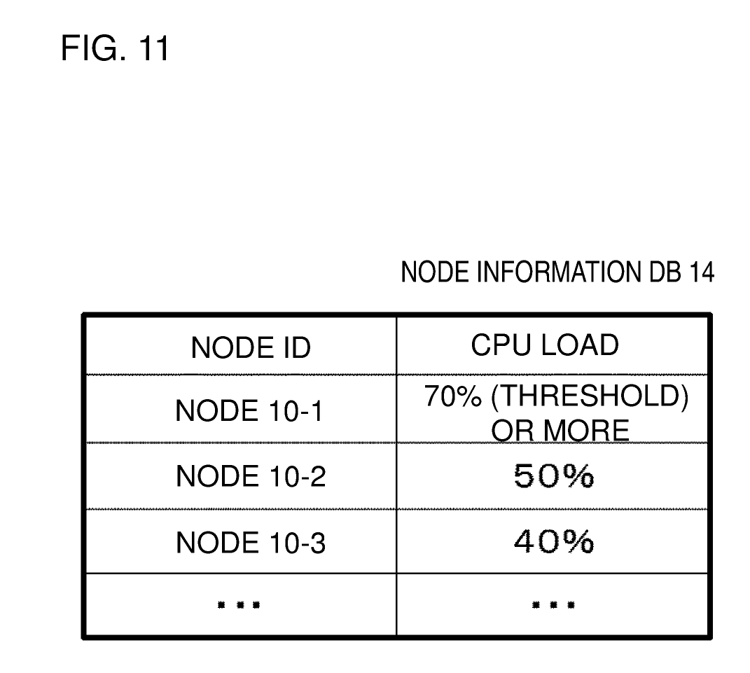

FIG. 11 illustrates an exemplary configuration of a table stored in the node information DB 14. As illustrated in FIG. 11, for example, per node 20, an ID of a node and the load on a CPU of the node are associated with each other in the node information DB 14. For example, the load on a CPU of a node 20 is represented by the utilization of the CPU. The information about the processing load on a node 20, the information being stored in the node information DB 14, is not limited to such CPU load. Any information about the processing load on the node 20 is applicable.

In the example in FIG. 11, for example, a node ID of the node 10-2 and 50%, which is the utilization of a CPU of the node 10-2, are associated with each other in the node information DB 14. In addition, in the example in FIG. 11, if the node 10-1 does not notify the control apparatus 10 of information about the load on a CPU of the node 10-1, information indicating that the CPU utilization of the node 10-1 is equal to or more than 70%, which is the threshold, is stored in the node information DB 14.

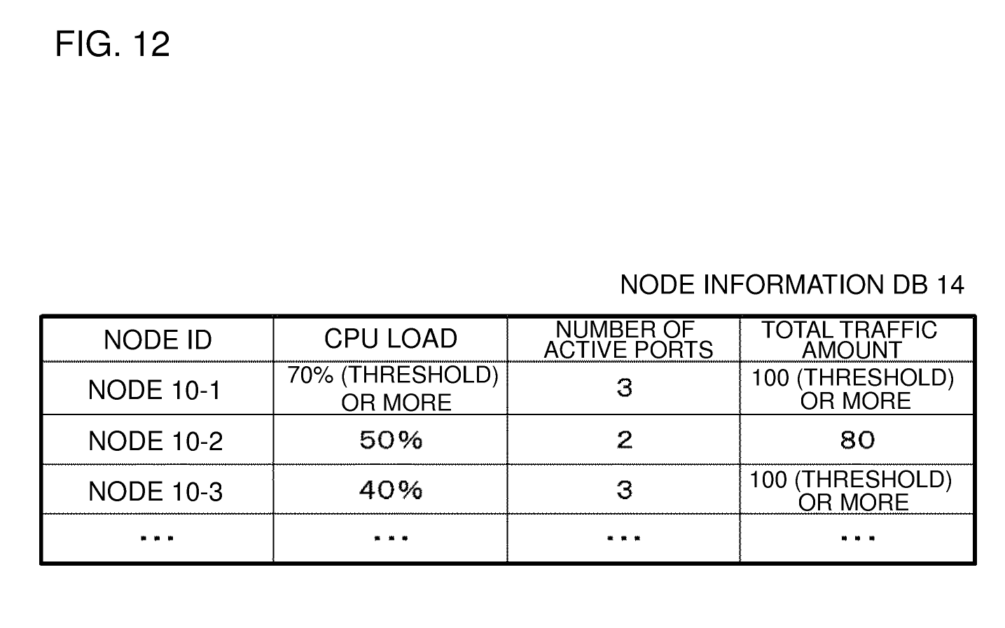

FIG. 12 illustrates another exemplary configuration of the table stored in the node information DB 14. As illustrated in FIG. 12, per node 20, a plurality of kinds of information about the processing load may be stored in the node information DB 14. For example, per node 20, an ID of a node, the load on a CPU of the node, the number of active ports of the node, and the total traffic amount of the node are associated with each other in the node information DB 14.

In the example in FIG. 12, for example, a node ID of the node 10-2, “50%,” which is the load on a CPU of the node 10-2, “2,” which is the number of active ports of the node 10-2, and “80,” which is the total traffic amount of the node 10-2 are associated with each other in the node information DB 14.

The information about a node 20, the information being stored in the node information DB 14, is not limited to the above examples. Any information about the processing load on a node 20 may be stored.

For example, when a node 20 notifies the control apparatus 10 of information about its processing load, the information stored in the node information DB 14 is updated. For example, the information stored in the node information DB 14 is updated at intervals of a predetermined period. For example, the information stored in the node information DB 14 is updated in accordance with an instruction from the control unit 12. For example, the information stored in the node information DB 14 is updated when the control unit 12 determines a node that is caused to notify the control apparatus 10 of a traffic amount.

For example, the control unit 12 refers to the node information DB 14 and collects, between two nodes connected to a link 30 whose traffic amount is to be collected, the traffic amount from a node having the smaller processing load. For example, the control unit 12 refers to the node information DB 14 in which the table in FIG. 11 is stored and collects the traffic amount of the link 30-1 from the node 20-2 having the smaller CPU load between the nodes 20-1 and 20-2 connected to the link 30-1.

If a plurality of kinds of information about the processing load on each node 20 are stored in the node information DB 14, the control unit 12 uses at least one of the plurality of kinds of information to determine a traffic amount collection node. For example, of all the information in the node information DB 14 in which the table in FIG. 12 is stored, the control unit 12 determines a traffic amount collection node based on the CPU load.

For example, the control unit 12 may allocate a priority to each of a plurality of kinds of information about the processing load on each node 20, the information being stored in the node information DB 14. In such case, the control unit 12 may determine a traffic amount collection node based on information having a high priority. For example, the control unit 12 sets the priority of the CPU load to be higher than that of the active port number in the node information DB 14. In such case, between two nodes connected to a link 30 whose traffic amount is to be collected, the control unit 12 determines a traffic amount collection node based on the CPU load whose priority is higher. For example, the control unit 12 refers to the node information DB 14 in which the table in FIG. 12 is stored and collects the traffic amount of the link 30-1 from the node 20-3 having the smaller CPU load, not from the node 20-1 having a smaller number of active ports.

For example, the control unit 12 may determine a traffic amount collection node based on a plurality of kinds of information among the kinds of information about the processing load on each node 20, the information being stored in the node information DB 14. For example, if both nodes connected to a link represent CPU load that is smaller than a predetermined threshold (70% in the example in FIG. 12), the control unit 12 determines a traffic amount collection node based on the number of active ports, not of the CPU load. For example, when collecting the traffic amount of the link 30-3, the control unit 12 refers to the node information DB 14 in which the table in FIG. 12 is stored and determines that the CPU load on the node 20-2 and the CPU load on the node 20-3 are smaller than a predetermined threshold. Thus, the control unit 12 collects the traffic amount of the link 30-3 from the node 20-2 having a smaller number of active ports, not from the node 20-3 having the smaller CPU load.

With such configuration as described above, the control apparatus 10 refers to the node information DB 14 included in the control apparatus 10 and determines a node 20 from which information about a link 30 is to be collected. Namely, when determining such a node 20, the control apparatus 10 can determine the node 20 without collecting node information sequentially. In addition, if a plurality of kinds of information about processing load on each node 20 is stored in the node information DB 14, the control apparatus 10 can determine a node 20 from which information about a link 30 is to be collected, in view of a plurality of kinds of information.

### Third Exemplary Embodiment

A third exemplary embodiment of the present invention will be described with reference to the drawings. In the third exemplary embodiment, a control apparatus 10 specifies a port, transmits a request for notification of information about a link to a node 20 having a plurality of ports, and receives notification of information about the link corresponding to the specified port. The third exemplary embodiment includes configurations that are equivalent to those according to the first and second exemplary embodiments, and the description of such configurations will be omitted.

The third exemplary embodiment of the present invention is applicable to any one of the above exemplary embodiments.

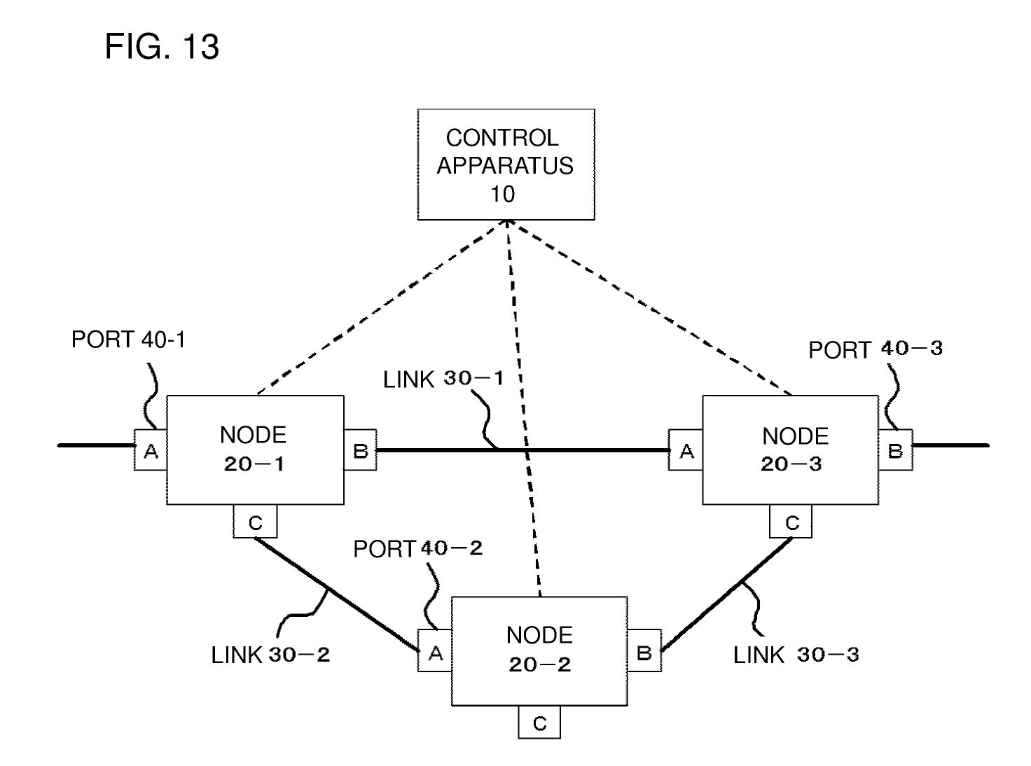

In the third exemplary embodiment of the present invention, as illustrated in FIG. 13, each node 20 has a plurality of ports 40-A to 40-C (each of the ports 40-A to 40-C will be referred to as a “port 40” unless these ports need to be distinguished from each other) and is connected to links 30 via the respective ports 40.

As illustrated in FIG. 13, each link 30 is connected to ports 40 of nodes 20. For example, the link 30-1 is connected to the port 40-1-B of the node 20-1 and to the port 40-3-A of the node 20-3.

From a plurality of nodes 20, the control apparatus 10 collects information about links 30 included in a network formed by the plurality of nodes 20. The third exemplary embodiment of the present invention will be described based on an example in which the control apparatus 10 collects the traffic amount of a link 30 as information about the link 30. However, the information about a link 30 collected by the control apparatus 10 is not limited to the traffic amount of the link 30.

An exemplary configuration of the control apparatus 10 according to the third exemplary embodiment of the present invention is the same as that of the control apparatus 10 according to the first and second exemplary embodiments of the present invention.

In the traffic amount DB 13 of the control apparatus 10, per link 30, information about ports connected to a link 30 is associated with a traffic amount(s) of the link 30 received from a node 20.

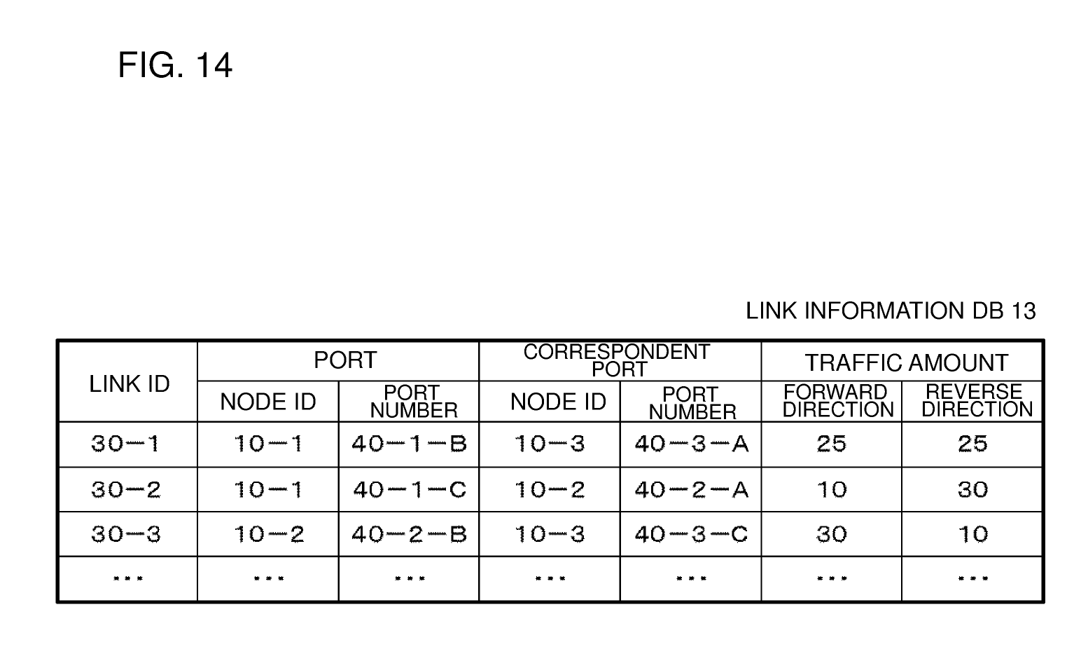

FIG. 14 illustrates an exemplary configuration of a table stored in the link information DB 13 included in the control apparatus 10 according to the third exemplary embodiment of the present invention. As illustrated in FIG. 14, in the link information DB 13, per link 30, information about ports 40 connected to a link 30 is associated with forward- and reverse-direction traffic amounts of the link 30. Alternatively, in the link information DB 13, per link 30, a total value of the forward- and reverse-direction traffic amounts may be stored. For example, the information about ports 40 includes identifiers of the nodes having the ports and port numbers of the ports.

In the example in FIG. 14, in the link information DB 13 included in the control apparatus 10, for example, the link ID of the link 30-2, the node ID of the node 10-1 and the port number of the port 40-1-C as information about a port, the node ID of the node 10-2 and the port number of the port 40-2-A as information about a correspondent port, “10” as the forward-direction traffic amount, and “30” as the reverse-direction traffic amount are associated with each other.

For example, between two nodes 20 connected to a link 30 whose traffic amount is to be collected, the control unit 12 collects the traffic amount from a node having the smaller processing load. For example, when the control unit 12 determines a traffic amount collection node 20, the communication unit 11 transmits a message that requests notification of the traffic amount to the determined node 20.

According to the third exemplary embodiment of the present invention, for example, the control unit 12 refers to the link information DB 13 and grasps the port number of the port 40 of the traffic amount collection node 20, the port 40 corresponding to the link 30. For example, when collecting the traffic amount of the link 30-2 from the node 20-2, the control unit 12 refers to the link information DB 13 and grasps that the port corresponding to the link 30-2 is the port 40-2-A of the node 20-2.

According to the third exemplary embodiment of the present invention, for example, the control unit 12 stores the port number of the port 40 corresponding to a link 30 whose traffic amount is to be collected in a message that requests notification of a traffic amount. For example, when collecting the traffic amount of the link 30-2, the control unit 12 stores the grasped port number of the port 40-2-A in a message that requests notification of the traffic amount. The node 20-2 notifies the control apparatus 10 of the traffic amounts transmitted and received via the port having the port number stored in the message.

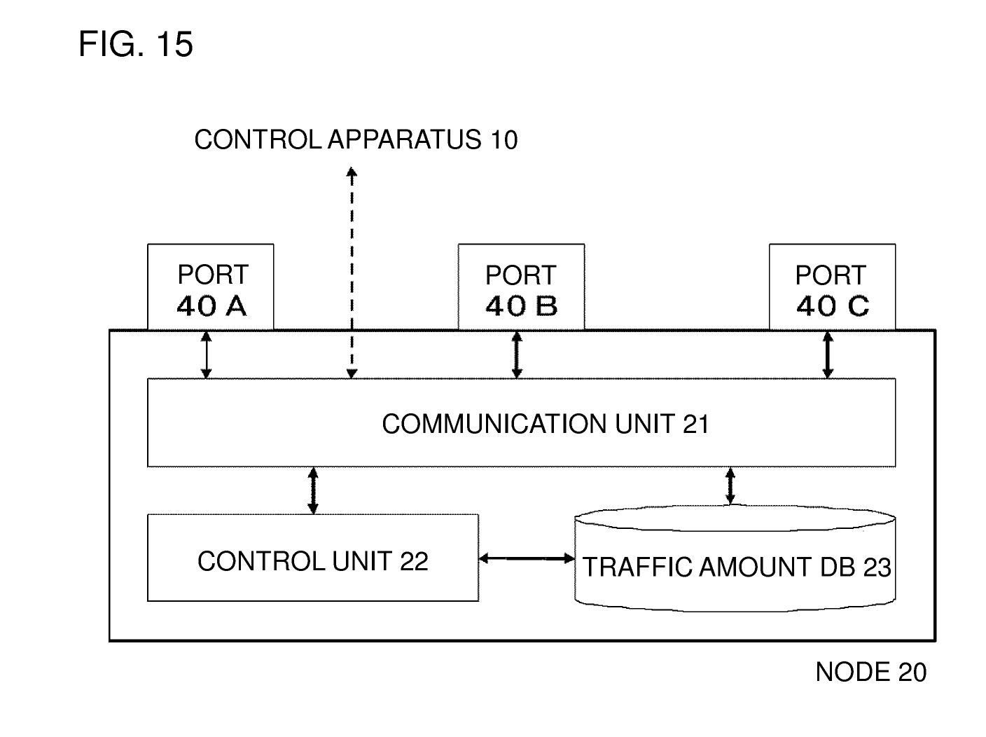

FIG. 15 illustrates an exemplary configuration of a node 20 according to the third exemplary embodiment of the present invention. As illustrated in FIG. 15, the node 20 includes a communication unit 21, a control unit 22, a traffic amount DB 23, and ports 40-A to 40-C.

The communication unit 21 transmits and receives packets via the ports 40.

In the traffic amount DB 23, per port 40 of the node 20, traffic amounts transmitted and received via a port are stored.

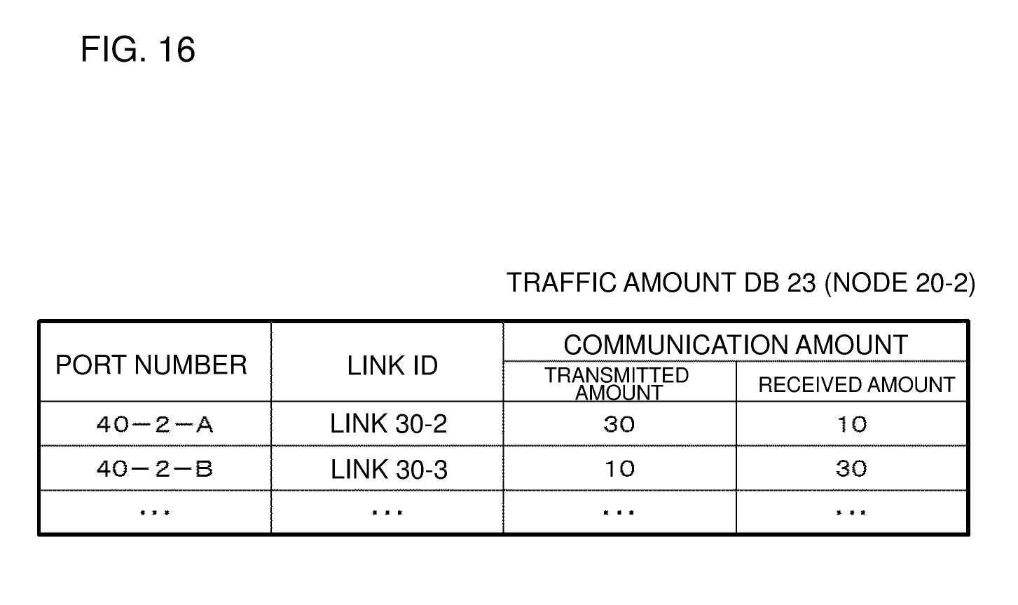

FIG. 16 illustrates an exemplary configuration of a table stored in the traffic amount DB 23 included in the node 20-2 according to the third exemplary embodiment of the present invention. For example, in the traffic amount DB 23, an ID of a link to which a port is connected and traffic amounts transmitted and received via the port are stored, per port 40 of the node 20. In the traffic amount DB 23 included in the node 20-2, an ID of a link to which a port is connected, a traffic amount (transmitted amount) transmitted via the port, and a traffic amount (received amount) received via the port are associated with each other, per port 40 of the node 20-2.

In the example in FIG. 16, for example, in the traffic amount DB 23 included in the node 20-2, the port identifier of the port 40-2-A, the link ID of the link 30-2, “30” as the transmitted traffic amount, and “10” as the received traffic amount are associated with each other.

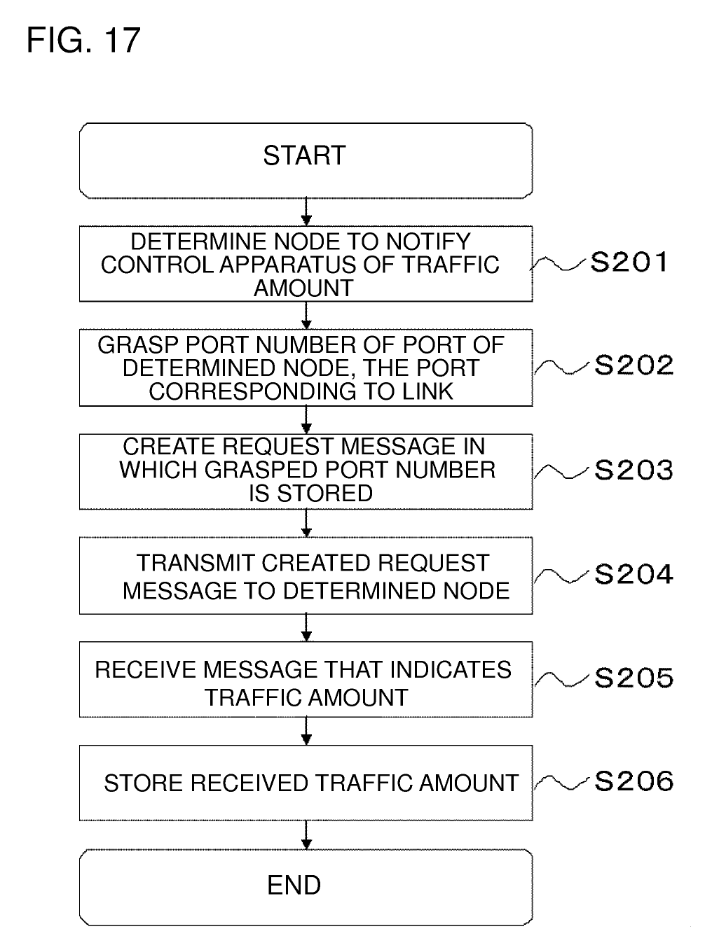

Next, an exemplary operation of the control apparatus 10 according to the third exemplary embodiment of the present invention will be described with reference to the drawings. FIG. 17 is a flowchart illustrating an operation of the control apparatus 10.

When a predetermined condition(s) is met, the control unit 12 of the control apparatus 10 starts collection of the traffic amount of a link 30.

Between nodes 20 connected to the link 30 whose traffic amount is to be collected, the control unit 12 determines a node having the smaller processing load to be the node that the control unit 12 requests for notification of the traffic amount (S201). Next, the control unit 12 refers to the link information DB 13 and grasps the port number of the port corresponding to the link whose traffic amount is to be collected (S202).

The control unit 12 creates a message that requests notification of the traffic amount, the message including the grasped port number (S203).

The communication unit 11 transmits the message created by the control unit 12 to the determined node (S204).

From the node, the communication unit 11 receives a message that indicates the traffic amount of the port corresponding to the link whose traffic amount is to be collected (S205).

The traffic amount included in the message received from the node 20 is stored in the link information DB 13 (S206).

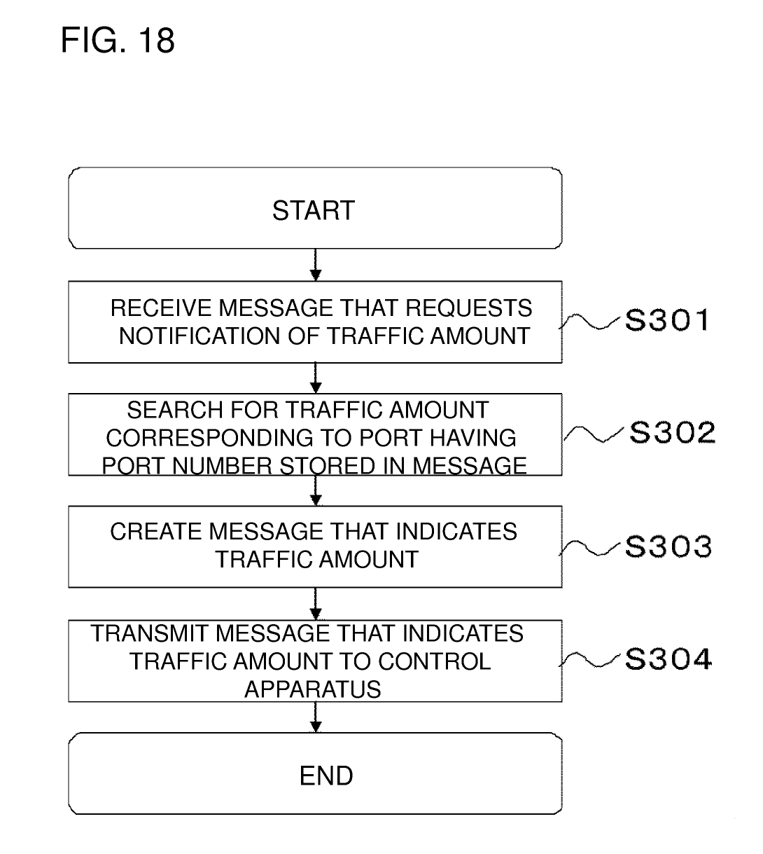

Next, an exemplary operation of a node 20 according to the third exemplary embodiment of the present invention will be described with reference to the drawings. FIG. 18 is a flowchart illustrating an operation of a node 20.

The communication unit 21 of the node 20 receives a message that requests notification of a traffic amount from the control apparatus 10 (S301).

The control unit 22 of the node 20 searches the traffic amount DB 23 for the traffic amount of the port specified in the message received by the communication unit 21 (S302).

The control unit 22 creates a message that notifies the control apparatus 10 of the traffic amount found (S303).

The communication unit 21 transmits the message created by the control unit 22 to the control apparatus 10 (S304).

With such configuration as described above, the control apparatus 10 specifies a port 40 and requests a node 20 to notify the control apparatus 10 of information about a link 30. Thus, the node 20 can respond to the request for the information about the link 30 from the control apparatus 10, without grasping a correspondence relationship between its ports 40 and the links 30 corresponding thereto.

### Fourth Exemplary Embodiment

Next, a fourth exemplary embodiment of the present invention will be described with reference to the drawings. According to the fourth exemplary embodiment, the control apparatus 10 refers to the link information DB 13 and determines link-related information collection node for each link in a network. The fourth exemplary embodiment includes configurations that are equivalent to those according to the first to third exemplary embodiments, and the description of such configurations will be omitted.

The fourth exemplary embodiment of the present invention is applicable to any one of the above exemplary embodiments.

From a plurality of nodes 20, the control apparatus 10 collects information about links 30 included in a network formed by the plurality of nodes 20. The fourth exemplary embodiment of the present invention will be described based on an example in which the control apparatus 10 collects the traffic amount of a link 30 as information about the link 30. However, the information about a link 30 collected by the control apparatus 10 is not limited to the traffic amount of the link 30.

An exemplary configuration of the control apparatus 10 according to the fourth exemplary embodiment of the present invention is the same as that of the control apparatus 10 according to the first to third exemplary embodiments of the present invention.

According to the fourth exemplary embodiment of the present invention, for example, a determination unit 120 sequentially determines traffic amount collection nodes 20, starting with a link 30 in the first row in a table stored in the link information DB 13. For example, after the determination unit 120 determines a node 20 to collect the traffic amount of a link 30 in a certain row of the table, the determination unit 120 determines a node 20 to collect the traffic amount of a link 30 in the next row (namely, the low immediately below the certain row).

Each time the determination unit 120 determines a node 20 to collect the traffic amount of a link 30, the determination unit 120 checks whether a traffic amount collection node 20 has been determined for each of the links 30 stored in the link information DB 13. For example, each time the determination unit 120 determines a node 20 to collect the traffic amount of a link 30, the determination unit 120 checks whether a traffic amount collection node has been determined up to the link 30 in the last row in the table stored in the link information DB 13.

For each row, from the link 30 in the first row to the link 30 in the last row in the link information DB 13, the determination unit 120 determines a traffic amount collection node 20. Thus, the determination unit 120 can determine a traffic amount collection node 20 for each of the links 30 stored in the link information DB 13.

According to the fourth exemplary embodiment of the present invention, in the link information DB 13, the link IDs allocated to the respective links 30 may be consecutive numbers. For example, the determination unit 120 determines the traffic amount collection nodes 20 for the links 30 in ascending order of the link IDs.

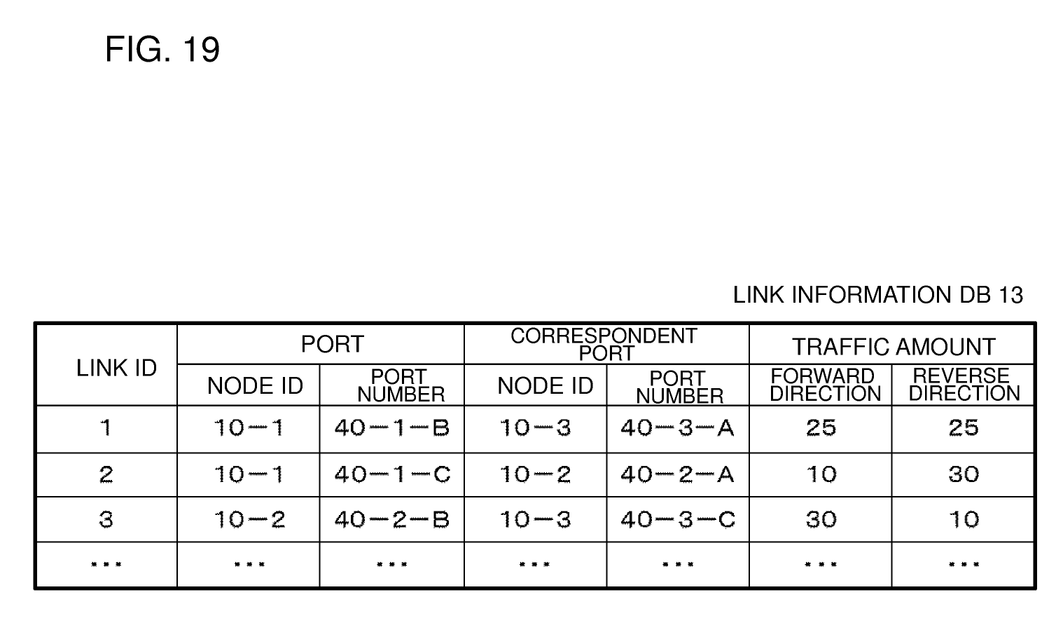

FIG. 19 illustrates an exemplary configuration of the link information DB 13 according to the fourth exemplary embodiment of the present invention. As illustrated in FIG. 19, in the link information DB 13, the link IDs allocated to the respective links 30 are consecutive numbers. In FIG. 19, the link IDs of the links 30-1 and 30-2 are “1” and “2,” respectively. The link IDs allocated to the respective links 30 may be any numbers as long as the numbers are consecutive numbers. A system other than the decimal number system may be used for the link IDs.

For example, first, for a link 30 having the smallest link ID, the determination unit 120 determines a traffic amount collection node 20. If the determination unit 120 refers to the link information DB 13 illustrated in FIG. 19, the determination unit 120 first determines a traffic amount collection node 20 for the link 30-1 whose link ID is “1.”

For example, after the determination unit 120 determines a traffic amount collection node 20 for a certain link 30, the determination unit 120 determines a traffic amount collection node 20 for a link 30 provided with the next link ID (namely, the link ID having a number larger by one level). If the determination unit 120 refers to the link information DB 13 illustrated in FIG. 19, after the determination unit 120 determines a traffic amount collection node 20 for the link 30-1 whose link ID is “1,” the determination unit 120 determines a traffic amount collection node 20 for the link 30-2 whose link ID is “2.”

For example, the determination unit 120 may manage the link IDs of the links 30, whose traffic amounts are collected by the nodes 20, as request link IDs. For example, when the determination unit 120 starts collection of the traffic amount of a link 30, the determination unit 120 sets the request link ID to a link ID having the smallest value stored in the link information DB 13. For example, after the determination unit 120 determines a traffic amount collection node 20 for a link 30, the determination unit 120 increments the request link ID.

For example, each time the determination unit 120 determines a traffic amount collection node 20 for a link 30, the determination unit 120 checks whether a traffic amount collection node has been determined up to for a link 30 having a link ID having the largest value stored in the link information DB 13. For example, each time the determination unit 120 determines a traffic amount collection node 20 for a link 30, the determination unit 120 checks whether the request link ID is the link ID having the largest value stored in the link information DB 13. For example, each time the determination unit 120 determines a traffic amount collection node 20 for a link 30, the determination unit 120 may check whether a link ID having a value larger than that of the request ID is stored in the link information DB 13.

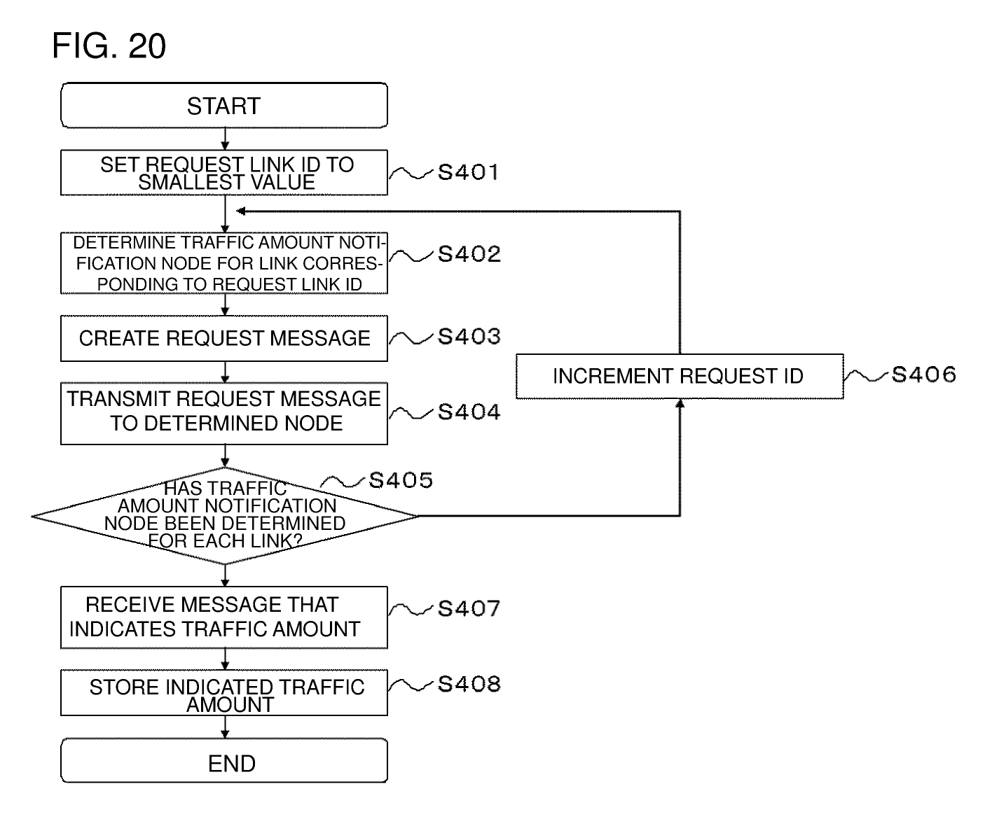

Next, an exemplary operation of the control apparatus 10 according to the fourth exemplary embodiment of the present invention will be described with reference to the drawings. FIG. 20 is a flowchart illustrating an operation of the control apparatus 10. This operation in FIG. 20 performed by the control apparatus 10 will be described based on an example in which the control apparatus 10 includes the link information DB 13 illustrated in FIG. 19.

When a predetermined condition(s) is met, the control unit 12 of the control apparatus 10 starts collection of the traffic amount of a link 30.

For example, the determination unit 120 sets the link ID to a link ID having the smallest value (S401).

For the link 30 whose link ID corresponds to the request link ID, between the two nodes 20 connected to the link 30, the control unit 12 determines a node having the smaller processing load to be the traffic amount collection node (S402).

Next, the control unit 12 creates a message that requests the determined node to notify the control unit 12 of the corresponding traffic amount (S403).

The communication unit 11 transmits the message created by the control unit 12 to the determined node (S404).

The control unit 12 refers to a determination management unit 121 and checks whether a traffic amount notification node 20 has been determined for each of the links 30 in the network (S405). For example, the control unit 12 checks whether the value of the request link ID is the largest link ID value stored in the link information DB.

As a result of the checking, if the control unit 12 determines that there is still a link 30 for which a traffic amount notification node 20 needs to be determined, the control unit 12 increments the request link ID (S406), returns to S402, and determines a traffic amount collection node 20 for the link 30 whose link ID corresponds to the request link ID.

The communication unit 11 receives a message that notifies the control apparatus 10 of the traffic amount of the link 30 from the node (S407) and stores relevant information in the link information DB 13 (S408).

With such configuration as described above, from all the links 30 in a network, the control apparatus 10 can collect information about the links 30 without fail.

### Fifth Exemplary Embodiment

Next, a fifth exemplary embodiment of the present invention will be described with reference to the drawings. According to the fifth exemplary embodiment, a control apparatus 10 includes a determination management unit in which information indicating whether link information collection nodes 20 have been determined for the links in a network, respectively, is stored.

The fifth exemplary embodiment of the present invention is applicable to any one of the above exemplary embodiments.

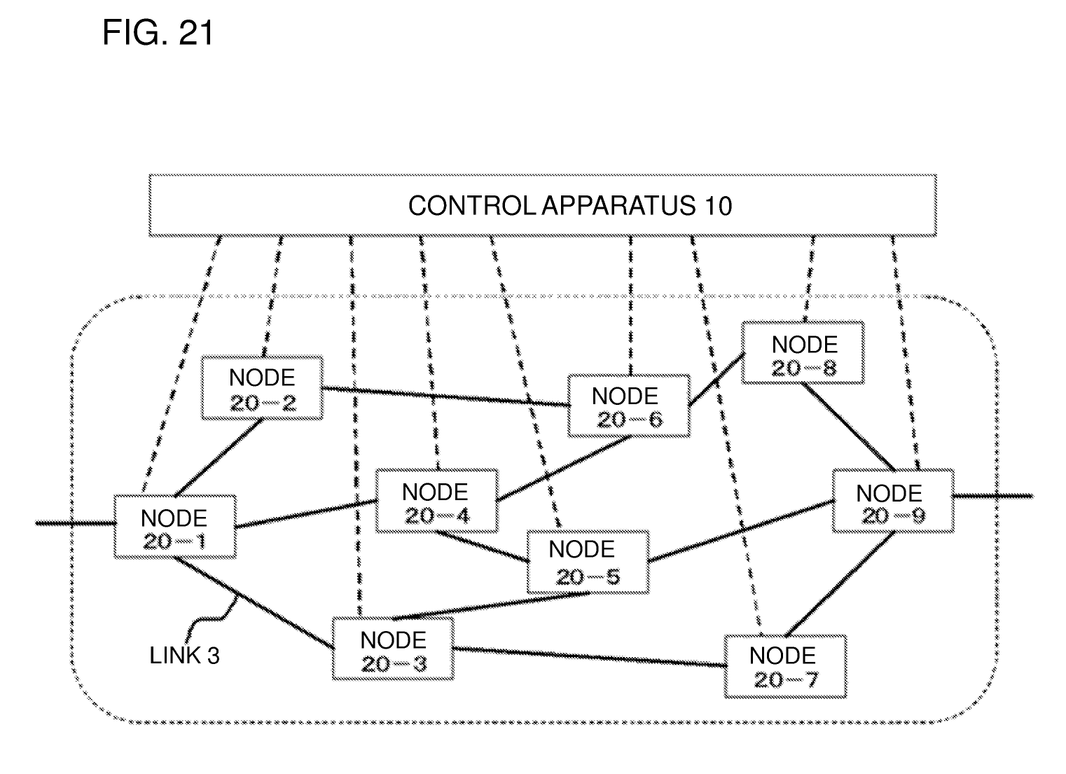

As illustrated in FIG. 21, the fifth exemplary embodiment of the present invention can be realized by a configuration including the control apparatus 10 and nodes 20-1 to 20-9. The number of nodes is not limited to that illustrated in FIG. 21. Any number of nodes may be used.

As illustrated in FIG. 21, each of the nodes 20-1 to 20-9 is connected to its neighboring node(s) via a link(s) 30.

From a plurality of nodes 20, the control apparatus 10 collects information about links 30 included in a network formed by the plurality of nodes 20. The fifth exemplary embodiment of the present invention will be described based on an example in which the control apparatus 10 collects the traffic amount of a link 30 as information about the link 30. However, the information about a link 30 collected by the control apparatus 10 is not limited to the traffic amount of the link 30.

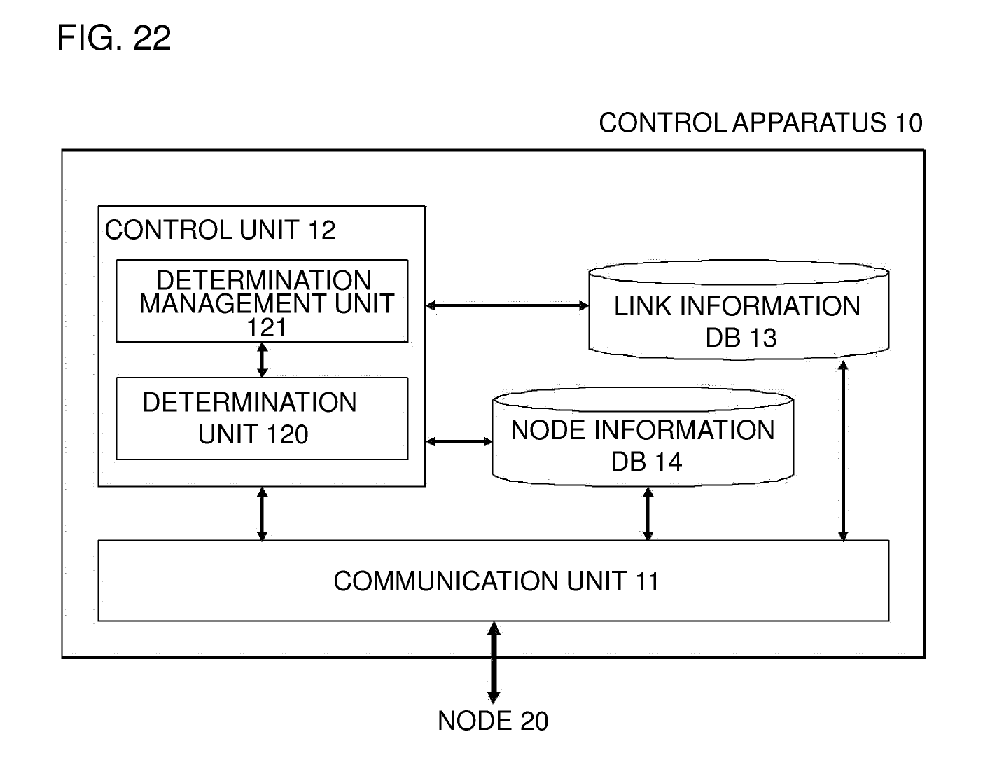

FIG. 22 illustrates an exemplary configuration of the control apparatus 10 according to the fifth exemplary embodiment of the present invention. As illustrated in FIG. 22, according to the fifth exemplary embodiment, the control unit 12 includes a determination unit 120 and a determination management unit 121.

For example, the determination unit 120 refers to the node information DB 14 and determines, between two nodes connected to a link 30, a node to collect the traffic amount of the link 30 based on the processing loads of the nodes. For example, between the two nodes connected to the link 30, the determination unit 120 determines a node having the smaller processing load to be the traffic amount collection node.

For example, after determining a traffic amount collection node 20, the determination unit 120 stores information about the determined node 20 and information about a port 40 via which the traffic amount is collected in the determination management unit 121.

For example, each time the determination unit 120 determines a traffic amount collection node 20, the determination unit 120 may store a flag indicating completion of determination of the traffic amount collection node 20.

For example, the determination unit 120 refers to the determination management unit 121 and checks whether a traffic amount collection node 20 has been determined for each of the links 30 in the network. For example, if there is still a link 30 for which a traffic amount collection node 20 has not been determined, the determination unit 120 determines a traffic amount collection node 20 for the link. The determination unit 120 determines a traffic amount collection node for each of the links 30 in the network.

For example, by referring to the determination management unit 121, the determination unit 120 determines whether information about a node 20 and information about a port 40 is stored for a link 30. If such information is stored, the determination unit 120 determines that a traffic amount collection node 20 has already been determined for that link. However, if the determination unit 120 determines that information about a node 20 and information about a port 40 is not stored for the link 30 by referring to the determination management unit 121, the determination unit 120 determines that no traffic amount collection node 20 has been determined for that link 30.

In addition, for example, the determination unit 120 may determine whether a traffic amount collection node 20 has been determined for each link 30 by referring to the determination management unit 121 in which flags are stored, each of the flags indicating completion of determination of a traffic amount collection node 20 for a link 30.

The method used by the determination unit 120 to check whether a traffic amount collection node 20 has been determined for each link 30 is not limited to the above example. Any method may be used.

For example, the determination management unit 121 manages, per link 30, a node 20 determined by the determination unit 120 and a port 40 corresponding to a link 30 whose traffic amount is collected. For example, in the determination management unit 121, a node ID of a node 20 determined by the determination unit 120 and a port 40 corresponding to a link 30 whose traffic amount is collected are associated with each other. For example, the determination management unit 121 manages, per link 30 in a network, a node 20 determined by the determination unit 120 and a port 40 corresponding to a link 30 whose traffic amount is collected.

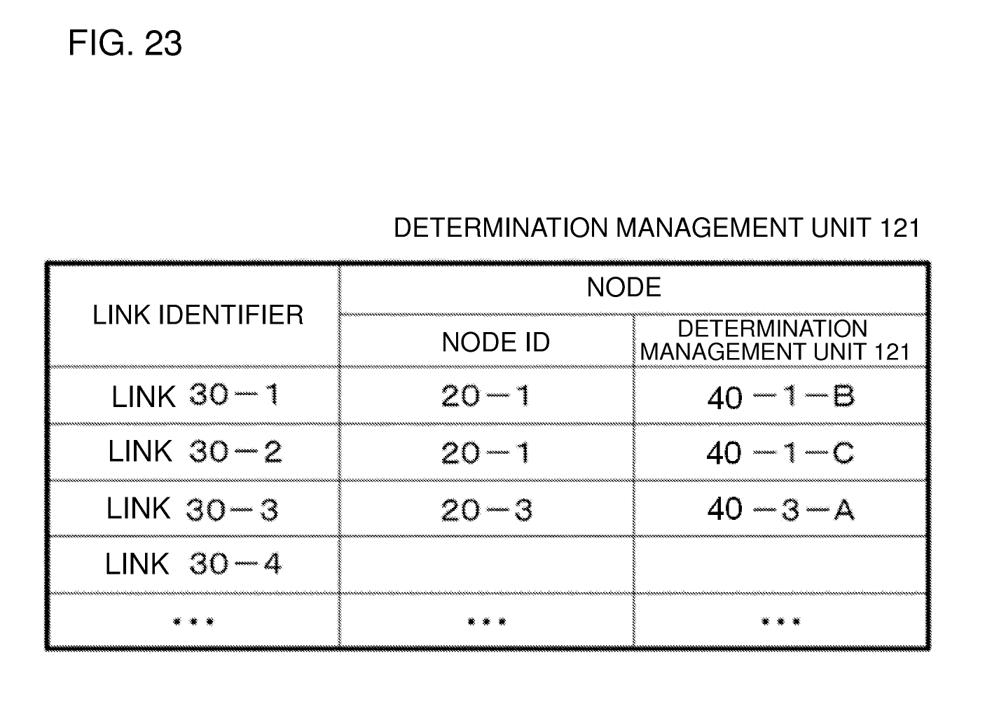

FIG. 23 illustrates an exemplary configuration of a table stored in the determination management unit 121 included in the control unit 120. As illustrated in FIG. 23, in the determination management unit 121, per link, a node ID of a determined node and a port number of a port corresponding to a link are associated with each other. In the example in FIG. 23, in the determination management unit 121, the link ID of the link 30-1, the node ID of the node 20-1 to collect the traffic amount of the link 30-1, and the port 40-B of the node 20-1 connected to the link 30-1 are associated with each other. In addition, in the example in FIG. 23, in the determination management unit 121, since a traffic amount collection node 20 has not been determined yet for the link 30-4, a node ID and a port number are not stored.

In addition, in the determination management unit 121, per link 30, a flag indicating completion of determination of a traffic amount collection node 20 may be stored.

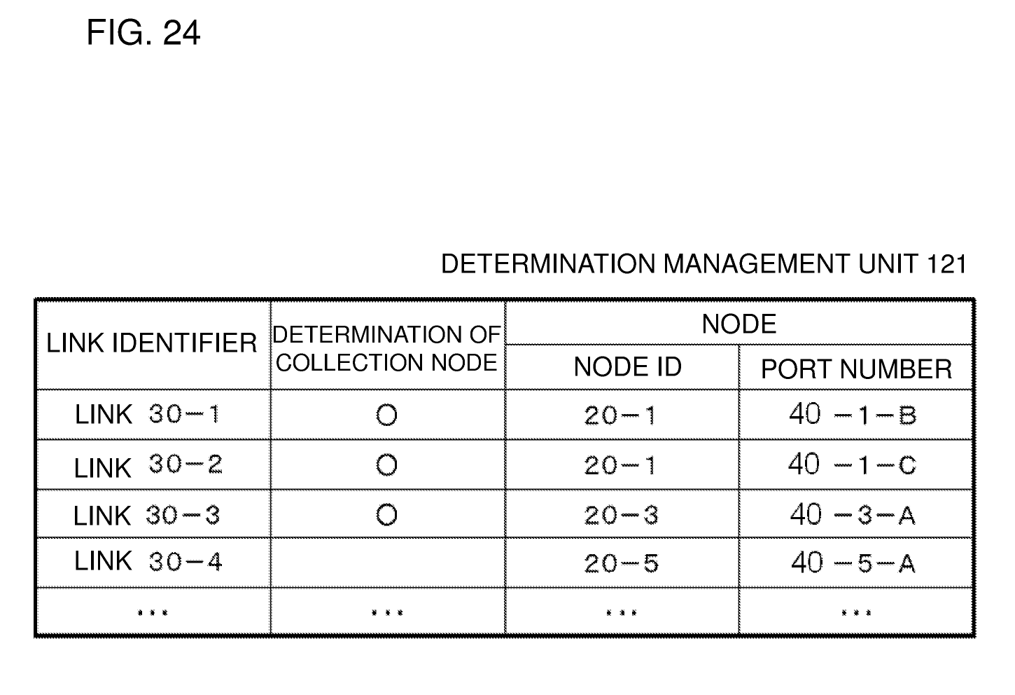

FIG. 24 illustrates another exemplary configuration of the table stored in the determination management unit 121 included in the control unit 120. As illustrated in FIG. 24, in the determination management unit 121, per link, a flag indicating completion of determination of a traffic amount collection node 20 is stored. In the example in FIG. 24, in the determination management unit 121, a flag denoted by “∘” is stored for a link for which a traffic amount collection node 20 has already been determined. In the example in FIG. 24, since the flag “∘” is stored for each of the links 30-1 to 30-3, the control unit 120 determines that a traffic amount collection node has already been determined for each of the links 30-1 to 30-3. In contrast, since the flag “∘” is not stored for the link 30-4, the control unit 120 determines that a traffic amount collection node has not been determined yet for the link 30-4.

For example, when the control apparatus 10 starts collection of the traffic amount of a link 30, the determination management unit 121 deletes information stored therein. For example, when the control apparatus 10 starts collection of the traffic amount of a link 30, the determination management unit 121 may deletes only the flags, each of which indicates completion of determination of a traffic amount collection node 20.

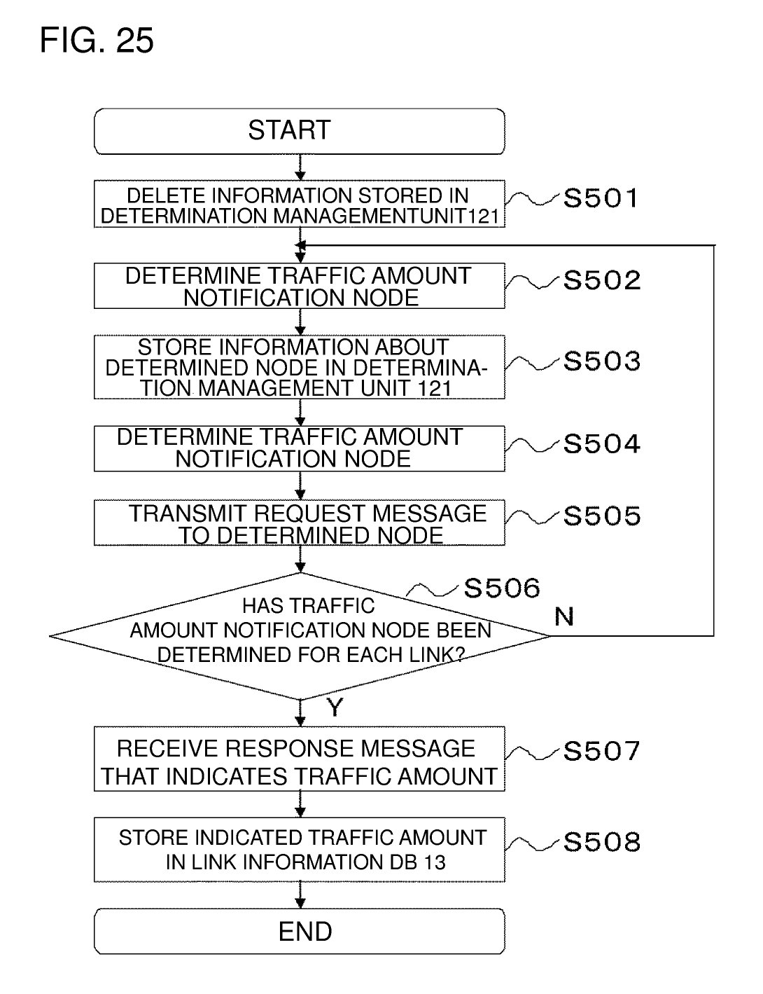

Next, an exemplary operation of the control apparatus 10 according to the fifth exemplary embodiment of the present invention will be described with reference to the drawings. FIG. 25 is a flowchart illustrating an operation of the control apparatus 10.

When a predetermined condition(s) is met, the control unit 12 of the control apparatus 10 starts collection of the traffic amount of a link 30.

When the control unit 12 starts collection of the traffic amount of a link, the control unit 12 deletes information stored in the determination management unit 121 (S501).

Between nodes 20 connected to the link whose traffic amount is to be collected, the control unit 12 determines a node having the smaller processing load to be the node that the control unit 12 requests for notification of the traffic amount (S502).

Next, the control unit 12 creates a message that requests notification of the traffic amount (S503). Next, for example, regarding the link 30 for which the traffic amount collection node 20 has been determined, the control unit 12 stores the node 20 determined by the determination unit 120 and a port 40 corresponding to the link 30 whose traffic amount is to be collected in the determination management unit 121 (S504).

The communication unit 11 transmits the message created by the control unit 12 to the determined node (S505).

The control unit 12 refers to the determination management unit 121 and checks whether a traffic amount notification node 20 has been determined for each of the links 30 in the network (S506). As a result of the checking, if there is still a link 30 for which a traffic amount notification node 20 has not been determined yet, the processing returns to S502, and the control unit 12 determines a traffic amount collection node 20 for that link 30.

The communication unit 11 receives a message that indicates the traffic amount of the link from the node 20 (S507) and stores the traffic amount of the link 20 included in the message received from the node in the link information DB 13 (S508).

With such configuration as described above, since the control apparatus 10 includes the determination management unit 121 in which, per link in the network, information indicating completion of determination of a node 20 to collect information about a link 30 is stored, the control apparatus 10 can efficiently collect information about the entire network system, as illustrated in FIG. 21, for example.

### Sixth Exemplary Embodiment

A sixth exemplary embodiment of the present invention is an example in which the present invention is realized by modifying a technique referred to as OpenFlow, which is a centralized-control-type network architecture.

The sixth exemplary embodiment is applicable to any one of the above exemplary embodiments.

OpenFlow recognizes communications as end-to-end flows and performs path control, etc. on a per-flow basis. Thus, by using OpenFlow in the present invention, a wireless access system can be controlled more flexibly based on communication fees.

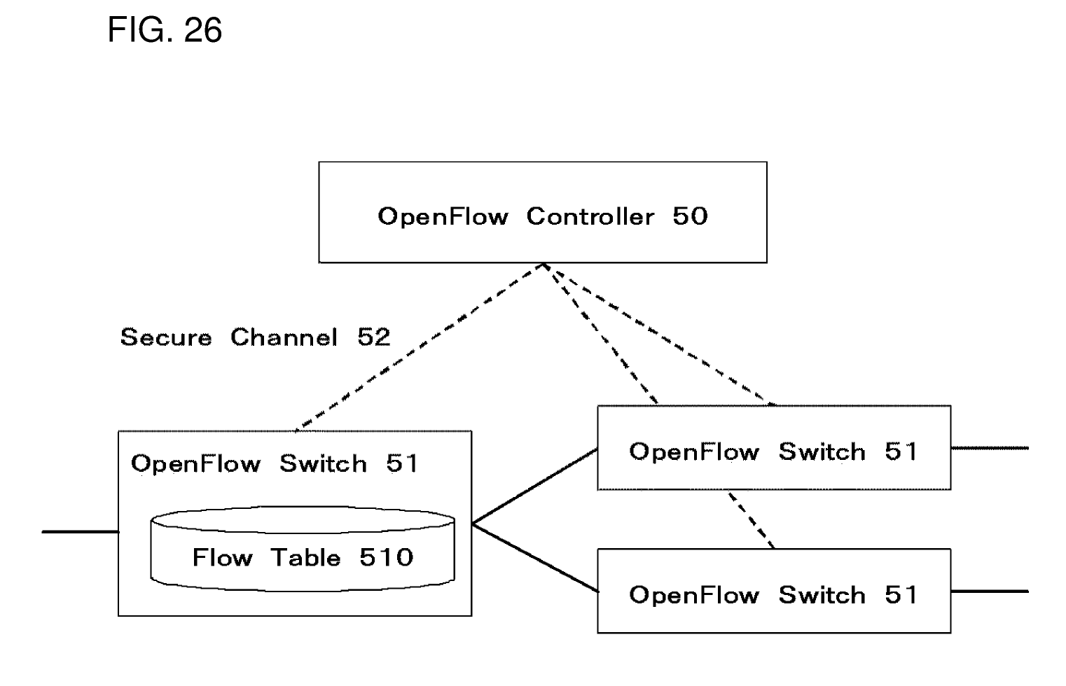

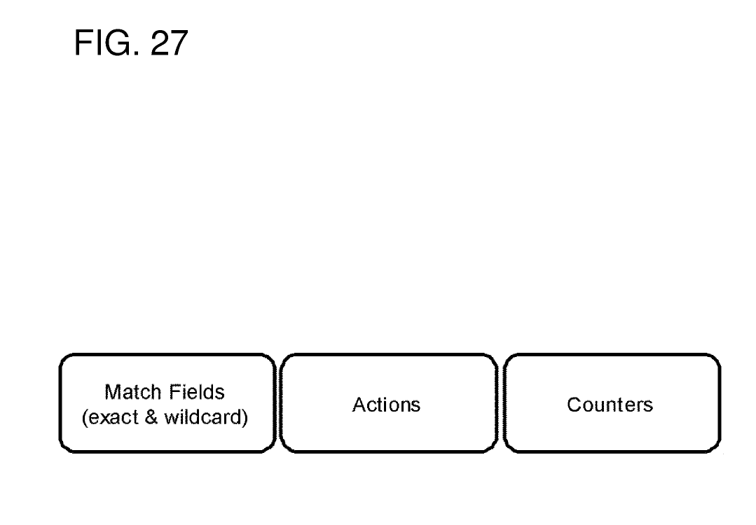

OpenFlow will be described with reference to FIGS. 26 and 27.

FIG. 26 illustrates an outline of a communication system established by an OpenFlow technique. For example, a flow is a series of communication packets having a predetermined attribute(s) (an attribute(s) identified by a communication destination, source, etc.). An OpenFlow switch 51 is a network switch that uses an OpenFlow technique. An OpenFlow controller 50 is an information processing apparatus that controls each OpenFlow switch 51.

A secure channel 52 is set between each OpenFlow switch 51 and the OpenFlow controller 50, and each OpenFlow switch 51 communicates with the OpenFlow controller 50 via its secure channel 52. Each OpenFlow switch 51 is provided with a flow table 510, and the OpenFlow controller 50 sets the flow table 510 of each OpenFlow switch 51 via the corresponding secure channel 52. Each secure channel 52 is a communication path on which measures for preventing eavesdropping, falsification, etc. on communication between its switch and the controller has been taken.

FIG. 27 illustrates an exemplary configuration of an entry (flow entry) in a flow table 510. The flow entry includes matching rules against which information (for example, a destination IP address, a VLAN ID, etc.) included in the header of a packet received by a switch is matched, statistical information (Counters), which is statistical information per packet flow, and action (Actions) that define a processing method(s) for packets that match the matching rules.

When an OpenFlow switch 51 receives a packet, the OpenFlow switch 51 refers to its flow table 510. The OpenFlow switch 51 searches for a flow entry that matches header information of the received packet. If the OpenFlow switch 51 finds an entry that matches header information of the received packet, the OpenFlow switch 51 processes the received packet in accordance with the processing method(s) defined in the action field of the entry found. For example, as such a processing method, “forward the received packet from a predetermined port,” “drop the received packet,” or “rewrite a portion of the header of the received packet and forward the packet from a predetermined port” is defined.

In contrast, if the OpenFlow switch 51 does not find an entry that matches header information of the received packet, the OpenFlow switch 51 forwards the received packet to the OpenFlow controller 50 via the secure channel 52, for example. By forwarding the received packet, the OpenFlow switch 51 requests the OpenFlow controller 50 to set a flow entry that defines a processing method(s) for the received packet.

The OpenFlow controller 50 determines a processing method(s) for the received packet and sets a flow entry including the determined processing method(s) in the flow table 510. Next, the OpenFlow switch 51 processes subsequent packets that belong to the same flow as the received packet in accordance with the set flow entry.

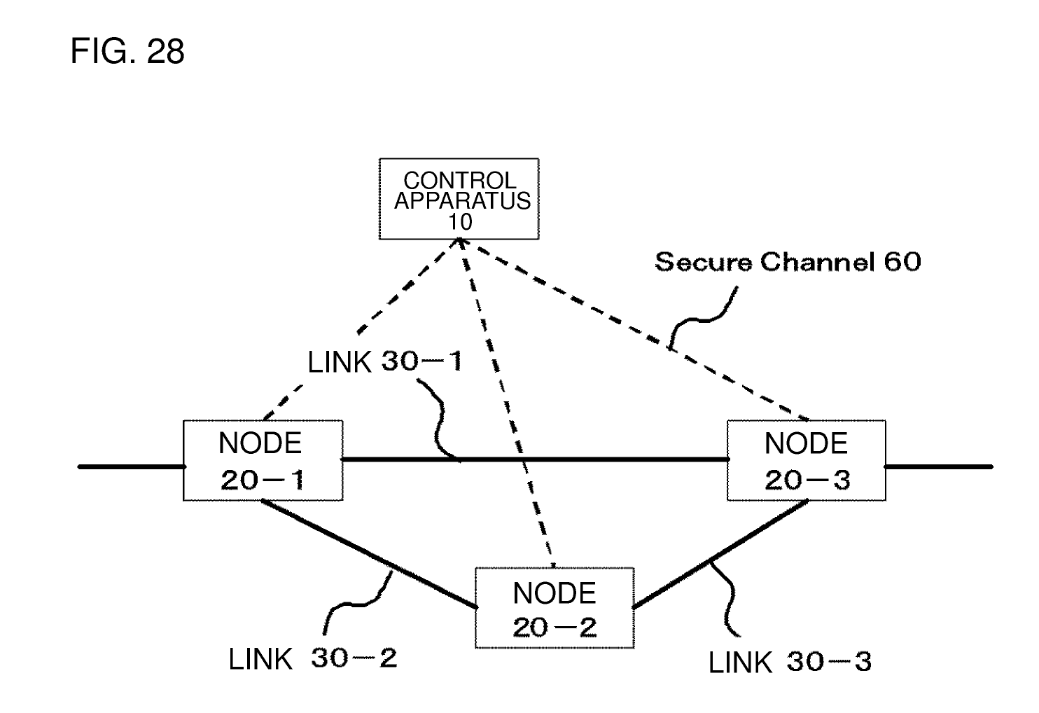

FIG. 28 illustrates an exemplary configuration of a system according to the sixth exemplary embodiment of the present invention, the system configured by modifying the above OpenFlow. As illustrated in FIG. 28, the sixth exemplary embodiment of the present invention can be realized by a configuration including a control apparatus 10, nodes 20, links 30, and secure channels 60.

From a plurality of nodes 20, the control apparatus 10 collects information about links 30 included in a network configured by the plurality of nodes 20. The sixth exemplary embodiment of the present invention will be described based on an example in which the control apparatus 10 collects the traffic amount of a link 30 as information about the link 30. However, information about a link 30 collected by the control apparatus 10 is not limited to the traffic amount of the link 30.

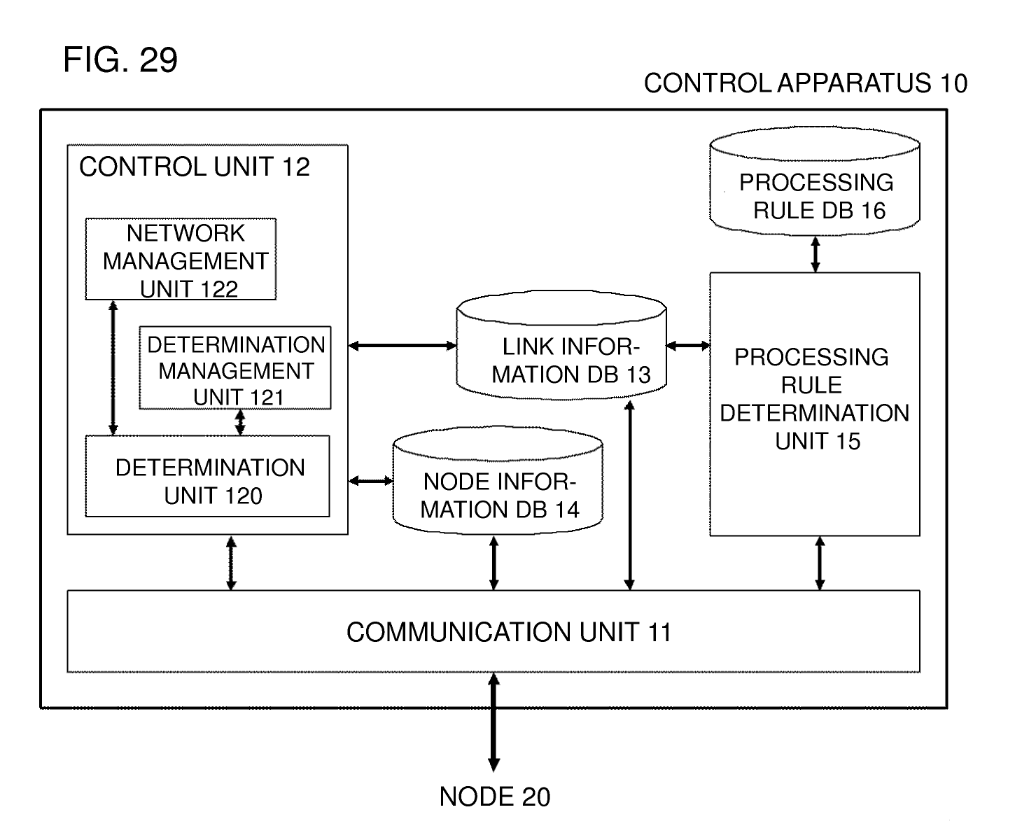

FIG. 29 illustrates an exemplary configuration of the control apparatus 10 according to the sixth exemplary embodiment of the present invention. The control apparatus 10 is an apparatus that is physically separated from the nodes 20. As illustrated in FIG. 29, the control apparatus 10 includes a communication unit 11, a control unit 12, a link information DB 13, a node information DB 14, a processing rule determination unit 15, and a processing rule DB 16.

The communication unit 11 serves as means for receiving requests for packet processing rules from the nodes 20. In addition, the communication unit 11 serves as means for notifying the nodes 20 of processing rules.

The determination unit 120 refers to the link information DB 13 and determines, between two nodes connected to a link 30, a node to collect the traffic amount of the link 30 based on the processing loads of the nodes. For example, the determination unit 120 determines, between two nodes connected to a link 30, a node having the smaller processing load to be the traffic amount collection node.

As illustrated in FIG. 29, the control unit 12 may include a network management unit 122. The network management unit 122 establishes topology information about a network managed by the control apparatus 10. For example, the network management unit 122 uses LLDP (Link Layer Discovery Protocol) to manage a topology of a network managed by the control apparatus 10.

For example, in addition to the information illustrated in FIG. 3 or FIG. 15, the topology information about the network established by the network management unit 122 may be stored in the link information DB 13.

In addition to the method described in any one of the first to fourth exemplary embodiments, information supplied by a function of an OpenFlow-compatible communication apparatus may be stored in the node information DB 14. Such an OpenFlow-compatible communication apparatus (a network switch, etc.) includes a function of notifying the controller of a status(es) of a port(s) of the communication apparatus (Port Status) or a function of notifying the controller of a feature(s) of the switch (Feature Request/Reply).

The processing rule determination unit 15 generates the processing rules for processing the packets received by the nodes 20.

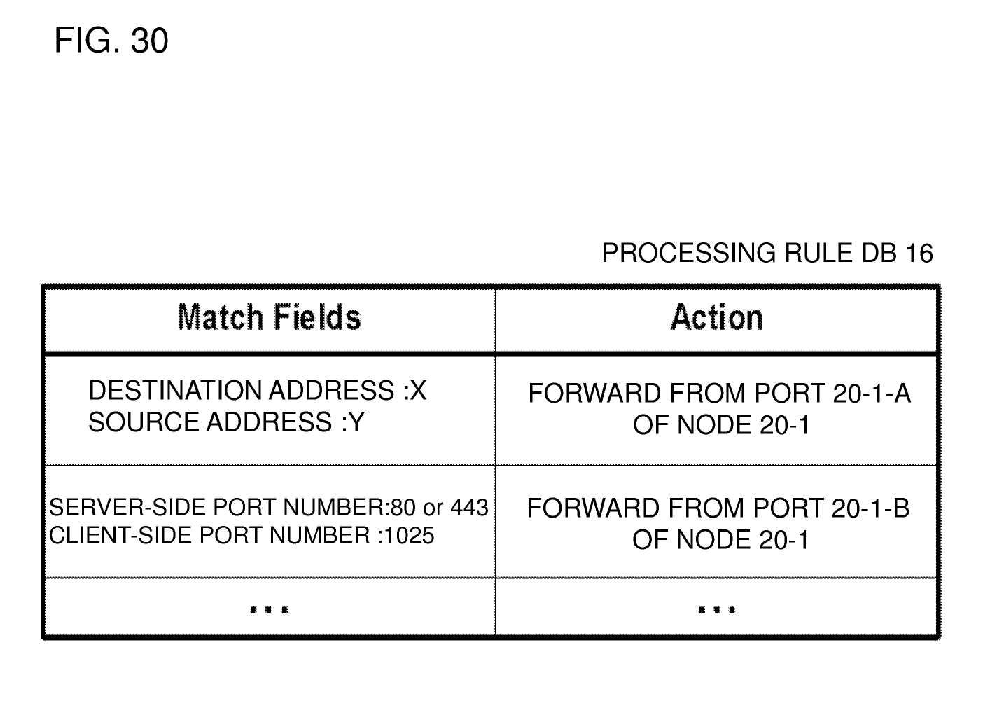

FIG. 30 illustrates exemplary processing rules generated by the processing rule determination unit 15. For example, these processing rules correspond to flow entries of OpenFlow. Each row in the table in FIG. 30 is a processing rule.

“Match Field” represents a condition(s) for identifying a flow. For example, a condition(s) for identifying a flow by using a communication port number or a condition(s) for identifying a flow based on information included in a packet (a destination address, a source address, etc.) is set in “Match Field.” In the example in FIG. 30, conditions that “the destination address is “X” and the source address “Y” are set in “Match Field.” In addition, in the example in

FIG. 30, conditions based on a client-side port number and a server-side port number are set in “Match Field.”

“Action” represents a processing method(s) for packets that belong to a flow that matches the condition(s) in “Match Field.” In the example in FIG. 30, an operation of forwarding packets from the port 40-1-B of the node 20-1 is set in the “Action” field.

For example, the processing rule determination unit 15 calculates a forwarding path(s) for packets received by a node 20. For example, the processing rule determination unit 15 refers to the link information DB 13 and calculate a forwarding path(s) for packets received by a node 20.

For example, the processing rule determination unit 15 refers to the link information DB 13, grasps a traffic status of a link 30 in the network, and calculate a forwarding path(s) for packets received by a node 20 based on the grasped traffic status. For example, the processing rule determination unit 15 refers to the link information DB 13 and calculates a forwarding path(s) for packets received by a node 20 so that the traffic of the link 30 in the network is distributed. For example, the processing rule determination unit 15 refers to the link information DB 13 and calculates a forwarding path(s) for packets received by a node 20 so that the traffic is not concentrated on a certain link.

For example, the processing rule determination unit 15 generates a processing rule(s) for forwarding packets received by a node 20 based on a calculated forwarding path(s).

The processing rule determination unit 15 notifies at least one node 20 of the generated processing rule(s) via the communication unit 11.

The processing rules generated by the processing rule determination unit 15 are stored in the processing rule DB 16.

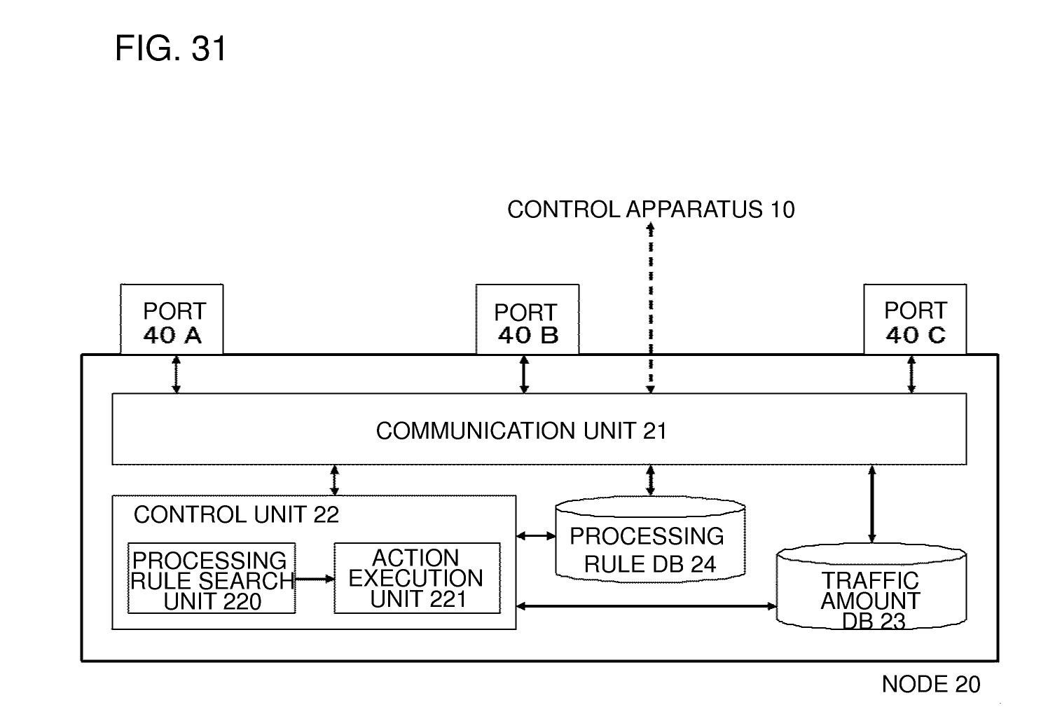

FIG. 31 illustrates an exemplary configuration of a node 20 according to the sixth exemplary embodiment of the present invention. As illustrated in FIG. 31, the node 20 includes a communication unit 21, a control unit 22, a traffic amount DB 23, a processing rule DB 24, and ports 40. The control unit 22 includes a processing rule search unit 220 and an action execution unit 221.

The communication unit 21 communicates with the control apparatus 10 in accordance with an OpenFlow protocol.

The control unit 22 processes packets in accordance with processing rules supplied from the control apparatus 10.

The processing rule search unit 220 searches the processing rule DB 24 for a processing rule that corresponds to a received packet. The processing rule search unit 220 determines whether the packet matches “Match Field” of any of the processing rules stored in the processing rule DB 24. In this way, the processing rule search unit 220 searches for a processing rule that corresponds to the packet.

The action execution unit 221 processes the packet in accordance with the processing method(s) defined in the “Action” field in the processing rule found.

For example, if the processing rule DB 24 does not include a processing rule matching the received packet, the processing rule search unit 220 requests the control apparatus 10 to set a processing rule.

In addition, in response to a request from the control apparatus 10, the control unit 22 notifies the control apparatus 10 of a traffic amount stored in the traffic amount DB 23.

The processing rules supplied from the control apparatus 10 are stored in the processing rule DB 24.

Next, an exemplary operation of the control apparatus 10 according to the sixth exemplary embodiment of the present invention will be described with reference to the drawings.

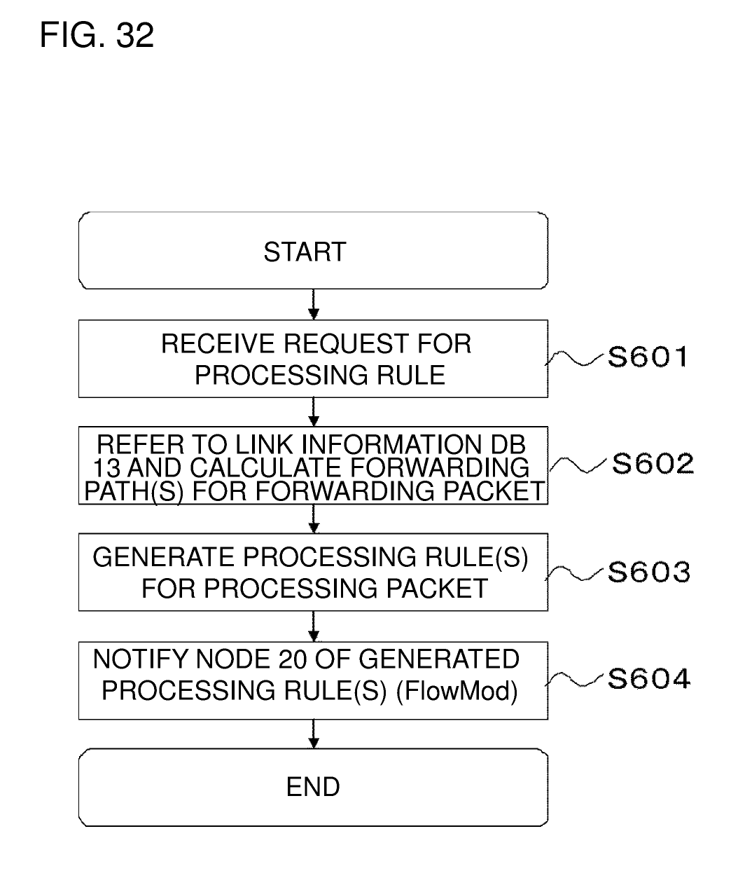

FIG. 32 illustrates an exemplary operation of the control apparatus 10 according to the sixth exemplary embodiment of the present invention. The control apparatus 10 performs the operation when the control apparatus 10 sets a processing rule in at least one node 20. According to the sixth exemplary embodiment of the present invention, an exemplary operation of the control apparatus 10 performed to collect the traffic amount of a link 30 is the same as that according to any one of the first to fifth exemplary embodiments.

The communication unit 11 receives a request for a processing rule for processing a packet from a node 20 (S601). In addition to the request for the processing rule from the node 20, the communication unit 11 is notified of the packet received by the node 20.

The processing rule determination unit 15 refers to the link information DB 13 and calculates a forwarding path(s) for forwarding the packet received by the node 20 (S602).

The processing rule determination unit 15 generates a processing rule(s) for at least one node 20, based on the calculated forwarding path(s) (S603).

The processing rule determination unit 15 notifies the node 20 of the generated processing rule via the communication unit 11 (S604; FlowMod). The processing rule determination unit 15 notifies the node 20, which has requested the processing rule, of the processing rule, and returns the packet received in S602.

Next, an exemplary operation of a node 20 according to the sixth exemplary embodiment of the present invention will be described with reference to the drawings.

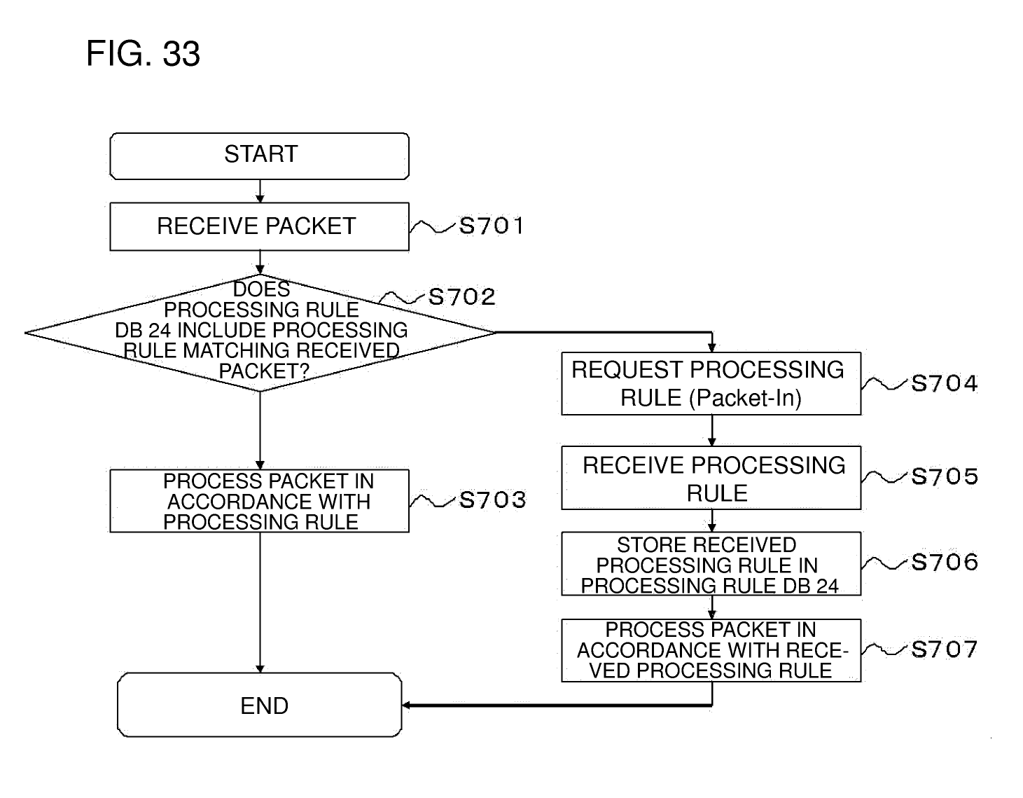

FIG. 33 illustrates an exemplary operation performed when a node 20 according to the sixth exemplary embodiment of the present invention is provided with a processing rule for processing packets by the control apparatus 10.

As illustrated in FIG. 33, first, at least one node 20 receives a packet (S701).

When the node 20 receives a packet, the processing rule search unit 220 of the node 20 searches the processing rule DB 24 for a processing rule having a match field(s) that matches the received packet (S702).

As a result of the search, if the processing rule search unit 220 finds a matching processing rule, the action execution unit 221 processes the packet in accordance with the processing rule (S703).

However, as a result of the search, if the processing rule search unit 220 does not find a matching processing rule, the control unit 22 transmits a processing rule setting request to the control apparatus 10 along with the received packet (S704; Packet-In).

The communication unit 21 receives a processing rule supplied from the control apparatus 10, in response to the request for a processing rule made by the processing rule search unit 220 (S705). The communication unit 21 receives (regains) the packet transmitted in 5604 from the control apparatus 10 along with the processing rule. The received processing rule is stored in the processing rule DB 24 (S706).

The action execution unit 221 processes the packet returned from the control apparatus 10 in accordance with the processing rule supplied from the control apparatus 10 (S707).

With such configuration as described above, the present invention can be realized by modifying a technique referred to as OpenFlow, which is a centralized-control-type network architecture.

The disclosure of the above PTLs is incorporated herein by reference thereto. Modifications and adjustments of the exemplary embodiments are possible within the scope of the overall disclosure (including the claims) of the present invention and based on the basic technical concept of the present invention. In addition, various combinations and selections of various disclosed elements (including the elements in each of the claims, exemplary embodiments, drawings, etc.) are possible within the scope of the disclosure of the present invention. Namely, the present invention of course includes various variations and modifications that could be made by those skilled in the art according to the overall disclosure including the claims and the technical concept. In particular, the present description discloses numerical value ranges. However, even if the description does not particularly disclose arbitrary numerical values or small ranges included in the ranges, these values and ranges should be deemed to have been specifically disclosed.

According to the present invention, the following modes are possible.

(Mode 1)

A communication system, comprising:

a plurality of nodes;

a link(s) for forwarding a packet(s) between (and/or among) the plurality of nodes; and

a control apparatus that collects information about the link(s) from a node selected based on a load on the node from the plurality of nodes.

(Mode 2)

The communication system according to mode 1, wherein the control apparatus selects a node whose load is below a predetermined threshold from the plurality of nodes connected to the link(s).

(Mode 3)

The communication system according to mode 1 or 2, wherein the control apparatus requests the selected node to transmit a traffic amount of the link(s) as information about the link(s), and the selected node notifies the control apparatus of the traffic amount of the link(s).

(Mode 4)

The communication system according to any one of modes 1 to 3, wherein

the control apparatus transmits to the selected node a message including an identifier(s) that identifies the link(s), and

the selected node notifies the control apparatus of information about the link(s) that corresponds to the identifier(s).

(Mode 5)

The communication system according to any one of modes 1 to 3, wherein

the plurality of nodes include ports connected to the link(s),

the control apparatus requests the selected node to provide information about the link(s) by transmitting a message including an identifier(s) that identifies a port(s) connected to the link(s), and

the selected node notifies the control apparatus of information about the link(s) connected to the port(s) that corresponds to the identifier(s).

(Mode 6)

The communication system according to any one of modes 1 to 5, wherein

the control apparatus comprises first storage means that stores a load(s) supplied from the plurality of nodes, and

the control apparatus refers to the first storage means to select a node(s) that collects information about the link(s).

(Mode 7)

The communication system according to any one of modes 1 to 6, wherein

the control apparatus comprises management means that manages information indicating whether a node for collecting information on the link(s) has already been determined for the link(s), and

the control apparatus refers to the management means to determine for the link(s) the node for collecting the information on the link(s).

(Mode 8)

The communication system according to any one of modes 1 to 7, wherein

the control apparatus refers to information about the link(s), calculates a forwarding path(s) for a received packet(s), and notifies a node(s) on the forwarding path(s) of a processing rule(s) for forwarding the packet(s) on the forwarding path(s).

(Mode 9)

A control apparatus in a communication system including a plurality of nodes and a link(s) for forwarding a packet(s) between (and/or among) the plurality of nodes;

wherein the control apparatus selects a node based on a load on the node from the plurality of nodes and collects information about the link(s) from the selected node.

(Mode 10)

The control apparatus according to mode 9, wherein

the control apparatus selects a node whose load is below a predetermined threshold from the plurality of nodes connected to the link(s).

(Mode 11)

The control apparatus according to mode 9 or 10, wherein

the control apparatus requests the selected node to transmit a traffic amount of the link(s) as information about the link(s), and

the selected node notifies the control apparatus of the traffic amount of the link(s).

(Mode 12)

The control apparatus according to any one of modes 9 to 11, wherein

the control apparatus transmits to the selected node a message including an identifier(s) that identifies the link(s), and

the selected node notifies the control apparatus of information about the link(s) that corresponds to the identifier(s).

(Mode 13)

The control apparatus according to any one of modes 9 to 11, wherein

the plurality of nodes include ports connected to the link(s),

the control apparatus requests the selected node to provide information about the link(s) by transmitting a message including an identifier(s) that identifies a port(s) connected to the link(s), and

the selected node notifies the control apparatus of information about the link(s) connected to the port(s) that corresponds to the identifier(s).

(Mode 14)

The control apparatus according to any one of modes 9 to 13, wherein

the control apparatus comprises first storage means that stores a load(s) supplied from the plurality of nodes, and

the control apparatus refers to the first storage means to select a node(s) that collects information about the link(s).

(Mode 15)

The control apparatus according to any one of modes 9 to 14, wherein

the control apparatus comprises management means that manages information indicating whether a node for collecting information on the link(s) has already been determined for the link(s), and

the control apparatus refers to the management means to determine for the link(s) the node for collecting the information on the link(s).

(Mode 16)

The control apparatus according to any one of modes 9 to 15, wherein the control apparatus refers to information about the link(s), calculates a forwarding path(s) for a received packet(s), and notifies a node(s) on the forwarding path(s) of a processing rule(s) for forwarding the packet(s) on the forwarding path(s).

(Mode 17)

An information collection method in a communication system including a plurality of nodes and a link(s) for forwarding a packet(s) between (and/or among) the plurality of nodes, the information collection method comprising:

selecting a node based on a load on the node from the plurality of nodes; and

collecting information about the link(s) from the selected node.

(Mode 18)

The information collection method according to mode 17, comprising:

selecting a node whose load is below a predetermined threshold from the plurality of nodes connected to the link(s).

(Mode 19)

The information collection method according to mode 17 or 18, comprising:

requesting the selected node to transmit a traffic amount of the link(s) as information about the link(s); and

collecting the traffic amount of the link(s) from the selected node.

(Mode 20)

The information collection method according to any one of modes 17 to 19, comprising:

transmitting to the selected node a message including an identifier(s) that identifies the link(s); and

collecting information about the link(s) that corresponds to the identifier(s) from the selected node.

(Mode 21)

The information collection method according to any one of modes 17 to 19, wherein

the plurality of nodes include ports connected to the link(s), and the information collection method comprises:

requesting the selected node to provide information about the link(s) through a message including an identifier(s) that identifies a port(s) connected to the link(s); and

collecting information about the link(s) connected to the port(s) that corresponds to the identifier(s) from the selected node.

(Mode 22)

The information collection method according to any one of modes 17 to 21, comprising:

storing a load(s) supplied from the plurality of nodes; and

selecting a node(s) that collects information about the link(s) by referring to the stored load(s).

(Mode 23)

The information collection method according to any one of modes 17 to 22, comprising:

managing information indicating whether a node for collecting information on the link(s) has already been determined for the link(s); and

determining for the link(s) the node for collecting the information on the link(s) by referring to the managed information.

(Mode 24)

The information collection method according to any one of modes 17 to 23, comprising:

referring to information about the link(s), calculating a forwarding path(s) for a received packet(s), and notifying a node(s) on the forwarding path(s) of a processing rule(s) for forwarding the packet(s) on the forwarding path(s).

(Mode 25)

A program, causing a control apparatus in a communication system including a plurality of nodes and a link(s) for forwarding a packet(s) between (and/or among) the plurality of nodes to execute:

selecting a node based on a load on the node from the plurality of nodes; and

collecting information about the link(s) from the selected node.

(Mode 26)

The program according to mode 25, causing the control apparatus to execute:

selecting a node whose load is below a predetermined threshold from the plurality of nodes connected to the link(s).

(Mode 27)

The program according to mode 25 or 26, causing the control apparatus to execute:

requesting the selected node to transmit a traffic amount of the link(s) as information about the link(s); and

collecting the traffic amount of the link(s) from the selected node.

(Mode 28)

The program according to any one of modes 25 to 27, causing the control apparatus to execute:

transmitting to the selected node a message including an identifier(s) that identifies the link(s); and

collecting information about the link(s) that corresponds to the identifier(s) from the selected node.

(Mode 29)

The program according to any one of modes 25 to 27, wherein

the plurality of nodes include ports connected to the link(s), and the program causes the control apparatus to execute:

requesting the selected node to provide information about the link(s) by transmitting a message including an identifier(s) that identifies a port(s) connected to the link(s); and

collecting information about the link(s) connected to the port(s) that corresponds to the identifier(s) from the selected node.

(Mode 30)

The program according to any one of modes 25 to 29, causing the control apparatus to execute:

storing a load(s) supplied from the plurality of nodes; and

selecting a node(s) that collects information about the link(s) by referring to the stored load(s).

(Mode 31)

The program according to any one of modes 25 to 30, causing the control apparatus to execute:

managing information indicating whether a node for collecting information on the link(s) has already been determined for the link(s); and

determining for the link(s) the node for collecting the information on the link(s) by referring to the managed information.

(Mode 32)

The program according to any one of modes 25 to 31, causing the control apparatus to execute:

referring to information about the link(s), calculating a forwarding path(s) for a received packet(s), and notifying a node(s) on the forwarding path(s) of a processing rule(s) for forwarding the packet(s) on the forwarding path(s).

### REFERENCE SIGNS LIST

10 control apparatus
11 communication unit
12 control unit
13 link information DB
14 node information DB
15 processing rule determination unit
16 processing rule DB
20, 20-1 to 20-9 node
21 communication unit
22 control unit
23 traffic amount DB
24 processing rule DB
30, 30-1 to 30-4 link
40, 40-1 to 40-3 port
50 OpenFlow controller
51 OpenFlow switch
52 secure channel
60 secure channel
120 determination unit
121 determination management unit
122 network management unit
220 processing rule search unit
221 action execution unit
510 flow table

What is claimed is:

1. A communication system, comprising:
a plurality of nodes;
a link(s) for forwarding a packet(s) between (and/or among) the plurality of nodes; and
a control apparatus that collects information about the link(s) from a node selected based on a load on the node from the plurality of nodes.

2. The communication system according to claim 1, wherein
the control apparatus selects a node whose load is below a predetermined threshold from the plurality of nodes connected to the link(s).

3. The communication system according to claim 1, wherein
the control apparatus requests the selected node to transmit a traffic amount of the link(s) as information about the link(s), and
the selected node notifies the control apparatus of the traffic amount of the link(s).

4. The communication system according to claim 1, wherein
the control apparatus transmits to the selected node a message including an identifier(s) that identifies the link(s), and
the selected node notifies the control apparatus of information about the link(s) that corresponds to the identifier(s).

5. The communication system according to claim 1, wherein
the plurality of nodes include ports connected to the link(s),
the control apparatus requests the selected node to provide information about the link(s) by transmitting a message including an identifier(s) that identifies a port(s) connected to the link(s), and
the selected node notifies the control apparatus of information about the link(s) connected to the port(s) that corresponds to the identifier(s).

6. The communication system according to claim 1, wherein
the control apparatus comprises a first storage unit that stores a load(s) supplied from the plurality of nodes, and
the control apparatus refers to the first storage means to select a node(s) that collects information about the link(s).

7. The communication system according to claim 1, wherein
the control apparatus comprises a management unit that manages information indicating whether a node for collecting information on the link(s) has already been determined for the link(s), and
the control apparatus refers to the management unit to determine for the link(s) the node for collecting the information on the link(s).

8. The communication system according to claim 1, wherein
the control apparatus refers to information about the link(s), calculates a forwarding path(s) for a received packet(s), and notifies a node(s) on the forwarding path(s) of a processing rule(s) for forwarding the packet(s) on the forwarding path(s).

9. A control apparatus in a communication system including a plurality of nodes and a link(s) for forwarding a packet(s) between (and/or among) the plurality of nodes;
wherein the control apparatus selects a node based on a load on the node from the plurality of nodes and collects information about the link(s) from the selected node.

10. The control apparatus according to claim 9, wherein
the control apparatus selects a node whose load is below a predetermined threshold from the plurality of nodes connected to the link(s).

11. The control apparatus according to claim 9, wherein
the control apparatus requests the selected node to transmit a traffic amount of the link(s) as information about the link(s), and
the selected node notifies the control apparatus of the traffic amount of the link(s).

12. The control apparatus according to claim 9, wherein
the control apparatus transmits to the selected node a message including an identifier(s) that identifies the link(s), and
the selected node notifies the control apparatus of information about the link(s) that corresponds to the identifier(s).

13. The control apparatus according to claim 9, wherein
the plurality of nodes include ports connected to the link(s),
the control apparatus requests the selected node to provide information about the link(s) by transmitting a message including an identifier(s) that identifies a port(s) connected to the link(s), and
the selected node notifies the control apparatus of information about the link(s) connected to the port(s) that corresponds to the identifier(s).

14. The control apparatus according to claim 9, wherein
the control apparatus comprises a first storage unit that stores a load(s) supplied from the plurality of nodes, and
the control apparatus refers to the first storage unit to select a node(s) that collects information about the link(s).

15. The control apparatus according to claim 9, wherein
the control apparatus comprises a management unit that manages information indicating whether a node for collecting information on the link(s) has already been determined for the link(s), and
the control apparatus refers to the management unit to determine for the link(s) the node for collecting the information on the link(s).

16. The control apparatus according to claim 9, wherein
the control apparatus refers to information about the link(s), calculates a forwarding path(s) for a received packet(s), and notifies a node(s) on the forwarding path(s) of a processing rule(s) for forwarding the packet(s) on the forwarding path(s).

17. An information collection method in a communication system including a plurality of nodes and a link(s) for forwarding a packet(s) between (and/or among) the plurality of nodes, the information collection method comprising:
selecting a node based on a load on the node from the plurality of nodes; and
collecting information about the link(s) from the selected node.

18. The information collection method according to claim 17, further comprising:
selecting a node whose load is below a predetermined threshold from the plurality of nodes connected to the link(s).

19. The information collection method according to claim 17, further comprising:
requesting the selected node to transmit a traffic amount of the link(s) as information about the link(s); and
collecting the traffic amount of the link(s) from the selected node.

20. The information collection method according to claim 17, further comprising:
transmitting to the selected node a message including an identifier(s) that identifies the link(s); and
collecting information about the link(s) that corresponds to the identifier(s) from the selected node.

21. The information collection method according to claim 17, wherein
the plurality of nodes include ports connected to the link(s), and
the information collection method further comprises:
requesting the selected node to provide information about the link(s) through a message including an identifier(s) that identifies a port(s) connected to the link(s); and
collecting information about the link(s) connected to the port(s) that corresponds to the identifier(s) from the selected node.

22. The information collection method according to claim 17, further comprising:
storing a load(s) supplied from the plurality of nodes; and
selecting a node(s) that collects information about the link(s) by referring to the stored load(s).

23. The information collection method according to claim 17, further comprising:
managing information indicating whether a node for collecting information on the link(s) has already been determined for the link(s); and
determining for the link(s) the node for collecting the information on the link(s) by referring to the managed information.

24. The information collection method according to claim 17, further comprising:
referring to information about the link(s), calculating a forwarding path(s) for a received packet(s), and notifying a node(s) on the forwarding path(s) of a processing rule(s) for forwarding the packet(s) on the forwarding path(s).

25. A non-transitory computer-readable recording medium storing a program that causes a control apparatus in a communication system including a plurality of nodes and a link(s) for forwarding a packet(s) between (and/or among) the plurality of nodes to execute:
selecting a node based on a load on the node from the plurality of nodes; and
collecting information about the link(s) from the selected node.

26. The non-transitory computer-readable recording medium according to claim 25, wherein
the program further causes causing the control apparatus to execute:
selecting a node whose load is below a predetermined threshold from the plurality of nodes connected to the link(s).

27. The non-transitory computer-readable recording medium according to claim 25, wherein
the program further causes the control apparatus to execute:
requesting the selected node to transmit a traffic amount of the link(s) as information about the link(s); and
collecting the traffic amount of the link(s) from the selected node.

28. The non-transitory computer-readable recording medium according to claim 25, wherein
the program further causes the control apparatus to execute:
transmitting to the selected node a message including an identifier(s) that identifies the link(s); and
collecting information about the link(s) that corresponds to the identifier(s) from the selected node.

29. The non-transitory computer-readable recording medium according to claim 25, wherein
the plurality of nodes include ports connected to the link(s), and
the program further causes the control apparatus to execute:
requesting the selected node to provide information about the link(s) by transmitting a message including an identifier(s) that identifies a port(s) connected to the link(s); and
collecting information about the link(s) connected to the port(s) that corresponds to the identifier(s) from the selected node.

30. The non-transitory computer-readable recording medium according to claim 25, wherein
the program further causes the control apparatus to execute:
storing a load(s) supplied from the plurality of nodes; and
selecting a node(s) that collects information about the link(s) by referring to the stored load(s).

31. The non-transitory computer-readable recording medium according to claim 25, wherein
the program further causes the control apparatus to execute:
managing information indicating whether a node for collecting information on the link(s) has already been determined for the link(s); and
determining for the link(s) the node for collecting the information on the link(s) by referring to the managed information.

32. The non-transitory computer-readable recording medium according to claim 25, wherein
the program further causes the control apparatus to execute:
referring to information about the link(s), calculating a forwarding path(s) for a received packet(s), and notifying a node(s) on the forwarding path(s) of a processing rule(s) for forwarding the packet(s) on the forwarding path(s).
